(19) United States
(12) Patent Application Publication
(10) Pub. No.: US 2025/0224721 A1
(43) Pub. Date: Jul. 10, 2025

(54) CAUSALITY-BASED FLEET MATCHING

(71) Applicant: Applied Materials, Inc., Santa Clara, CA (US)

(72) Inventors: Sidharth Bhatia, Santa Cruz, CA (US); Steven Eduard Babayan, Los Altos, CA (US)

(21) Appl. No.: 18/408,439

(22) Filed: Jan. 9, 2024

(51) Int. Cl. G05B 23/02

(52) U.S. Cl. CPC G05B 23/0248; G05B 23/0275

(57) ABSTRACT

A method includes generating a product knowledge causal graph based on causal relationships between multiple sensors in one or more manufacturing systems, parts data of a plurality of parts of the manufacturing system, and equipment constant data of a plurality of equipment constants of the manufacturing system. The method further includes determining a causal strength index matrix. The method further includes, responsive to identifying an anomalous behavior in at least one of the plurality of sensors, determining a root cause of the anomalous behavior using at least one of the causal strength index matrix or the product knowledge causal graph. The method further includes identifying, based on at least a subset of the parts data corresponding to the root cause of the anomalous behavior, or a subset of the equipment constant data corresponding to the root cause of the anomalous behavior, at least one corrective action for the anomalous behavior.

### TECHNICAL FIELD

The present disclosure relates to determining causality in a system. More particularly, the present disclosure relates to causality-based fleet matching.

### BACKGROUND

Manufacturing systems, including substrate manufacturing systems, use manufacturing equipment to produce products (e.g., substrates). Manufacturing systems include sensors that may be causally related. Conventionally, system health has been assessed through manual inspections and performance metrics resulting in unplanned downtime and maintenance, disrupting regular operations, and leading to losses in efficiency and productivity.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure includes a method including generating a causal graph based on a plurality of values, each value corresponding to a causal relationship between two or more sensors of a plurality of sensors in one or more manufacturing systems. The method further includes determining a causal strength index matrix. The method further includes, responsive to identifying an anomalous behavior in at least one of the plurality of sensors, determining a root cause of the anomalous behavior using at least one of the causal strength index matrix or the causal graph. The method further includes causing a recommended corrective action to be issued based on the root cause of the anomalous behavior.

A further aspect of the disclosure includes a non-transitory computer-readable storage medium storing instructions which, when executed, cause a processing device to perform operations. The operations include generating a causal graph based on a plurality of values, each value corresponding to a causal relationship between two or more sensors of a plurality of sensors in one or more manufacturing systems. The operations further include determining a causal strength index matrix. The operations further include responsive to identifying an anomalous behavior in at least one of the plurality of sensors, determining a root cause of the anomalous behavior using at least one of the causal strength index matrix or the causal graph. The operations further include causing a recommended corrective action to be issued based on the root cause of the anomalous behavior.

A further aspect of the disclosure includes a system including a memory and a processing device coupled to the memory. The processing device is to generate a causal graph based on a plurality of values, each value corresponding to a causal relationship between two or more sensors of a plurality of sensors in one or more manufacturing systems. The processing device is further to determine a causal strength index matrix. The processing device is further to, responsive to identifying an anomalous behavior in at least one of the plurality of sensors, determine a root cause of the anomalous behavior using at least one of the causal strength index matrix or the causal graph. The processing device is further to cause a recommended corrective action to be issued based on the root cause of the anomalous behavior.

A further aspect of the disclosure includes a method including generating a product knowledge causal graph based on causal relationships between a plurality of sensors in one or more manufacturing systems, parts data of a plurality of parts of the manufacturing system, where each of the plurality of parts corresponds to at least one sensor of the plurality of sensor, and equipment constant data of a plurality of equipment constants of the manufacturing system, where the equipment constant data corresponds to at least one sensor of the plurality of sensors. The method further includes determining a causal strength index matrix. The method further includes, responsive to identifying an anomalous behavior in at least one of the plurality of sensors, determining a root cause of the anomalous behavior using at least one of the causal strength index matrix or the product knowledge causal graph. The method further includes identifying, based on at least a subset of the parts data corresponding to the root cause of the anomalous behavior, or a subset of the equipment constant data corresponding to the root cause of the anomalous behavior, at least one corrective action for the anomalous behavior.

A further aspect of the disclosure includes a non-transitory computer-readable storage medium storing instructions which, when executed, cause a processing device to perform operations. The operations include generating a product knowledge causal graph is based on causal relationships between a plurality of sensors in one or more manufacturing systems, parts data of a plurality of parts of the manufacturing system, where each of the plurality of parts corresponds to at least one sensor of the plurality of sensors, and equipment constant data of a plurality of equipment constants of the manufacturing system, where the equipment constant data corresponds to at least one sensor of the plurality of sensors. The operations further comprise determining a causal strength index matrix. The operations further comprise responsive to identifying an anomalous behavior in at least one of the plurality of sensors, determining a root cause of the anomalous behavior using at least one of the causal strength index matrix or the product knowledge causal graph. The operations further comprise identifying, based on at least a subset of the parts data corresponding to the root cause of the anomalous behavior, or a subset of the equipment constant data corresponding to the root cause of the anomalous behavior, at least one corrective action for the anomalous behavior.

A further aspect of the disclosure includes a system including a memory and a processing device coupled to the memory. The processing device is to generate a product knowledge causal graph based on causal relationships between a plurality of sensors in one or more manufacturing systems, parts data of a plurality of parts of the manufacturing system, where each of the plurality of parts corresponds to at least one sensor of the plurality of sensors, and equipment constant data of a plurality of equipment constants of the manufacturing system, where the equipment constant data corresponds to at least one sensor of the plurality of sensors. The processing device is further to determine a causal strength index matrix. The processing device is further to, responsive to identifying an anomalous behavior in at least one of the plurality of sensors, determine a root cause of the anomalous behavior using at least one of the causal strength index matrix or the product knowledge causal graph. The processing device is further to identify, based on at least a subset of the parts data corresponding to the root cause of the anomalous behavior, or a subset of the equipment constant data corresponding to the root cause of the anomalous behavior, at least one corrective action for the anomalous behavior.

### BRIEF DESCRIPTION OF THE DRAWINGS

The present disclosure is illustrated by way of example, and not by way of limitation in the figures of the accompanying drawings.

FIG. 1 is a block diagram illustrating an example system architecture, according to some embodiments.

FIG. 2A illustrates a data set generator associated with determining weights of directed edges, according to some embodiments.

FIG. 2B illustrates a data set generator associated with determining corrective actions and root causes for manufacturing systems, according to some embodiments.

FIG. 3 is a block diagram illustrating determining predictive data, according to some embodiments.

FIG. 4 is a directed acyclic graph (DAG), according to some embodiments.

FIGS. 5A-C are flow diagrams of methods associated with determining causality and determining weights of directed edges, according to some embodiments.

FIG. 6 is a product knowledge causal graph, according to some embodiments.

FIGS. 7A-D are flow diagrams of methods associated with determining corrective actions and root causes for manufacturing systems, according to some embodiments.

FIG. 8 is a block diagram illustrating a computer system, according to certain embodiments.

### DETAILED DESCRIPTION

Described herein are technologies directed to determining causality (e.g., in a semiconductor manufacturing system) and determining corrective actions and root causes for semiconductor manufacturing systems.

Semiconductor manufacturing systems are complex and require careful monitoring to maintain performance. However, the traditional statistical, empirical, and machine learning methods for tracing root causes and determining system health typically do not provide causal information, but only correlations. As a result, incorrect sensors or sub-systems are often assigned as root cause(s) for anomalous sensors and/or degraded system performance, leading to misguided corrective actions and increased downtime and costs. Furthermore, traditional methods for root cause tracing and corrective action determination may only consider corrective actions related to sensor nodes of a semiconductor manufacturing system. The many parts (including parts specifications and quality data) and equipment constants of the semiconductor manufacturing system that are related to sensor nodes may not be considered when determining a root cause and an appropriate corrective action. As a result, incorrect root causes and/or ineffective corrective actions for anomalous sensors may be determined leading to increased downtime and costs.

Current solutions for defining relationship between variables (e.g., sensors and/or sensor data) in a manufacturing system are correlation-based. This is because correlations can be found more easily than causations can be found and proven. Finding and proving causation often requires specialized knowledge of semiconductor manufacturing. Additionally, correlations can be misleading, as demonstrated, for example, by Simpson's paradox. This paradox occurs when a trend appears in different groups of data but disappears or reverses when the groups are combined. Current solutions do not capture a directed causal relationship between nodes (e.g., sensors), and the weights they learn for the causal relationships are often unstable, inaccurate, and have high bias or variance.

Current solutions for determining root causes and determining corrective actions do not consider product data (e.g., parts data and/or equipment constants data). Product data can be difficult to add to a semiconductor manufacturing system model that is based only on sensor nodes. Finding and proving relationship between product data of a semiconductor manufacturing system and sensor nodes of the system often requires specialized knowledge of semiconductor manufacturing. Thus, current solutions do not determine accurate root causes and affective corrective actions (e.g., related to the product data).

Aspects and implementations of the present disclosure address these and other shortcomings of the existing technology by performing causation determination in manufacturing systems (e.g., based on sensor nodes and product data) and using causality to determine corrective actions manufacturing systems (e.g., semiconductor manufacturing systems). In some embodiments, a causal graph (e.g., a directed acyclic graph (DAG)) can be created using, for example, Granger causality. The causal graph can represent the causal relationships between sensors in a manufacturing system, making it possible to diagnose the cause of an anomalous sensor. An anomalous sensor is a sensor and/or metrology tool that is collecting anomalous data (e.g., measurements that are outside the expected or normal range for a particular parameter). The causal graph can enable accurate root cause analysis (e.g., multiple ranked root causes), issuance of effective corrective actions (e.g., multiple ranked corrective actions), and system health factor index functionality.

The ability to capture a directed causal relationship between variables (e.g., sensors and/or sensor data in a semiconductor manufacturing system) enhances statistical, empirical, and machine learning methods to determine relationships between variables that alone only provide corollary information and not causal information. Furthermore, the ability to integrate product data (e.g., parts data and equipment constant data) into the directed causal relationships between variables enhances the accuracy and effectiveness of determining root causes and corrective actions. In some embodiments, sensors and/or sensor data (e.g., sensor values, measured values, etc.) in a manufacturing system are represented as variables due to the interconnectedness and causal relationships that can be exhibited. Changes in one sensor (e.g., a sensor measurement) often correlate with changes in other sensors, indicating a potential cause-and-effect relationship. For example, an increased temperature detected by a temperature sensor may cause an increase in pressure detected by a pressure sensor. Causal connections between variables (e.g., sensors, sensor data, sensor values, etc.) can show how the variability of sensor measurements directly influences the behavior and dynamics of the manufacturing system. In causal relationships one sensor may be a leading indicator (driver) that causes a change in and/or affects another sensor. Determining causal relationships between variables makes the present disclosure more accurate and efficient, leading to reduced downtime and costs.

Sensors in a manufacturing system can be associated with various parts (e.g., components). The sensors can be monitored to ensure the proper functioning of the parts of the manufacturing system. For example, detection of an anomalous sensor (e.g., a sensor collecting measurements that are outside the expected or normal range for a particular parameter) in the manufacturing system, may indicate a problem with a specific part, such as a malfunctioning RF cable. Sensors in a manufacturing system are associated with equipment constants (e.g., system constants). For example, detection of an anomalous sensor in the manufacturing system, can be attributed to faulty equipment constants or settings, such as a monitor timeout value that needs adjustment. These associations can help to identify issues (e.g., root causes), maintaining process integrity, and enabling timely maintenance or replacement of faulty components (e.g., corrective actions) to facilitate the smooth operation of the manufacturing system. The sensors of the manufacturing system can be represented by product knowledge causal graphs and causal strength index matrices. The integration of parts data and equipment constant data into the causal relationship structure of the sensors enhances accuracy and efficiency, leading to reduced downtime and costs.

In some embodiments, parts and/or equipment constants in a manufacturing system may be represented as variables of the semiconductor manufacturing system due to the interconnectedness and causal relationships that can be exhibited between the products (e.g., parts and equipment constants) and the sensors. Changes to one part or equipment constant often correlate with changes in sensors (e.g., a changed part or damaged part may trigger a change in a sensor), indicating a potential cause-and-effect relationship.

A processing device can generate a causal graph based on a plurality of values corresponding to causal relationships between sensors in one or more manufacturing systems. The causal graph can be a directed acyclic graph (DAG). The processing device can generate the DAG by combining cause and effect interdependencies from the causal strength index matrix and user input. The manufacturing systems can be, for example, wafer manufacturing systems (e.g., semiconductor manufacturing systems), and the sensors can monitor parameters of the wafer manufacturing systems.

The DAG may include nodes corresponding to sensors of the manufacturing system and directed edges having weights. The weights can be determined using a structural causal model. The structural causal model can be a machine learning model that is trained using historical sensor data and target output of historical causality data (e.g., weights data), to predict the weights of the directed edges.

The processing device can further assign a criticality value to each of the sensors of the manufacturing system. A criticality value may be a numerical value representing the critically of a sensor to a system. The processing device can further assign a system health factor index value to the manufacturing system.

Aspects of the present disclosure result in technological advantages. In particular, aspects of the present disclosure provide the ability to capture a directed causal relationship between nodes (e.g., sensors in a wafer manufacturing system), enhancing the use of traditional statistical, empirical, and machine learning method based relationship determination between variables by providing causation instead of correlation. Aspects of the present disclosure capture a directed causal relationship between variables (e.g., sensors, sensor values, sensor data, etc.), causing the strength and direction of these relationships to be learned accurately and without over-sensitivity to changes in data. Thus, and the weights of the causal relationships learned are more stable, accurate, and have low bias and/or variance. Aspects of the present disclosure, provide more accurate and efficient root cause analysis because causal relationships (instead of correlative relationships) including parts data and equipment constant data are used to determine root causes, leading to reduced downtime and costs (e.g., parts replacement, installation costs, etc.). As a result, sensors or sub-systems are accurately assigned as root cause(s) for degraded system performance, leading to effective corrective actions related to parts or equipment constants causing decreased downtime and costs. Aspects of the present disclosure, provide a system health factor index, reducing misguided troubleshooting.

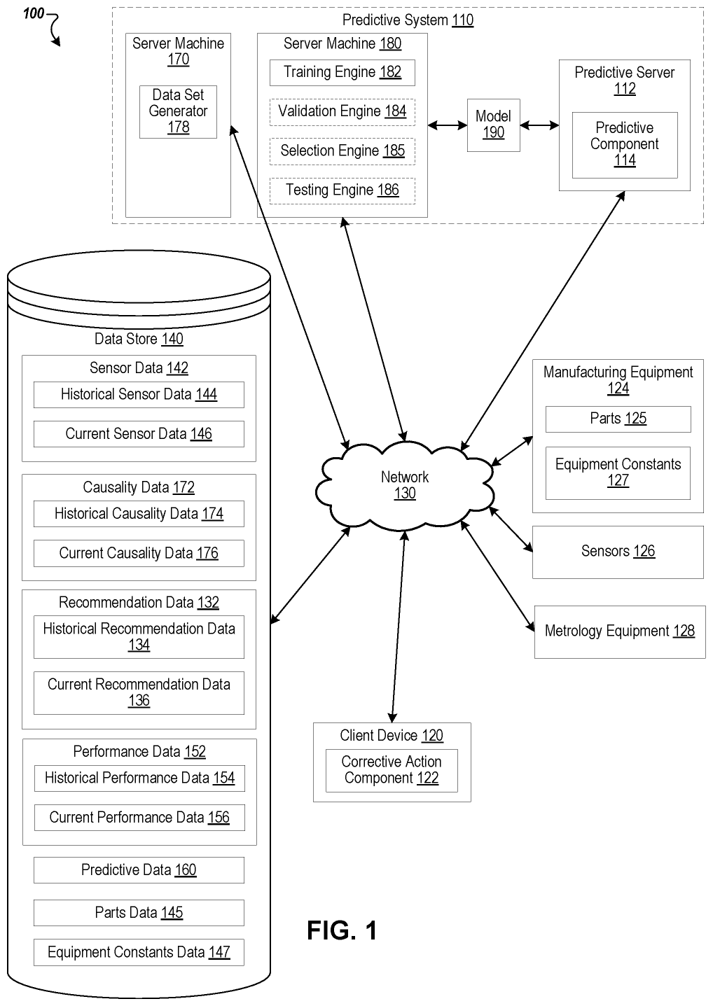

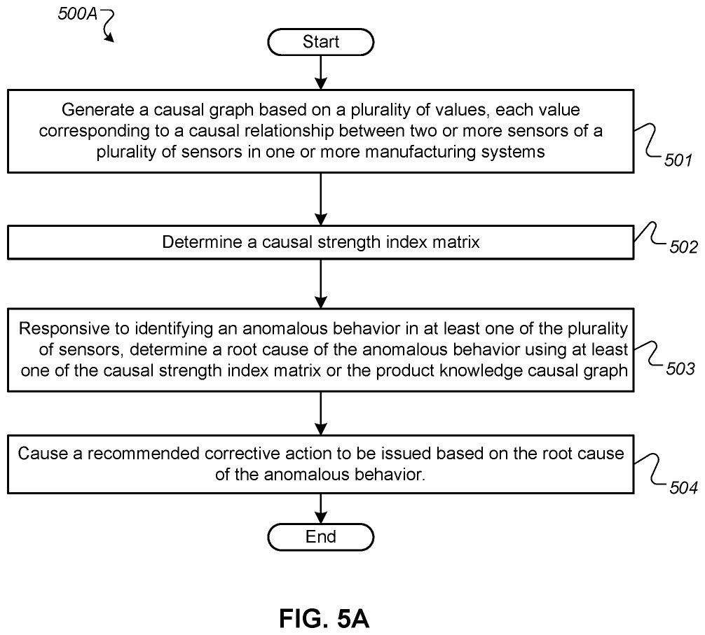

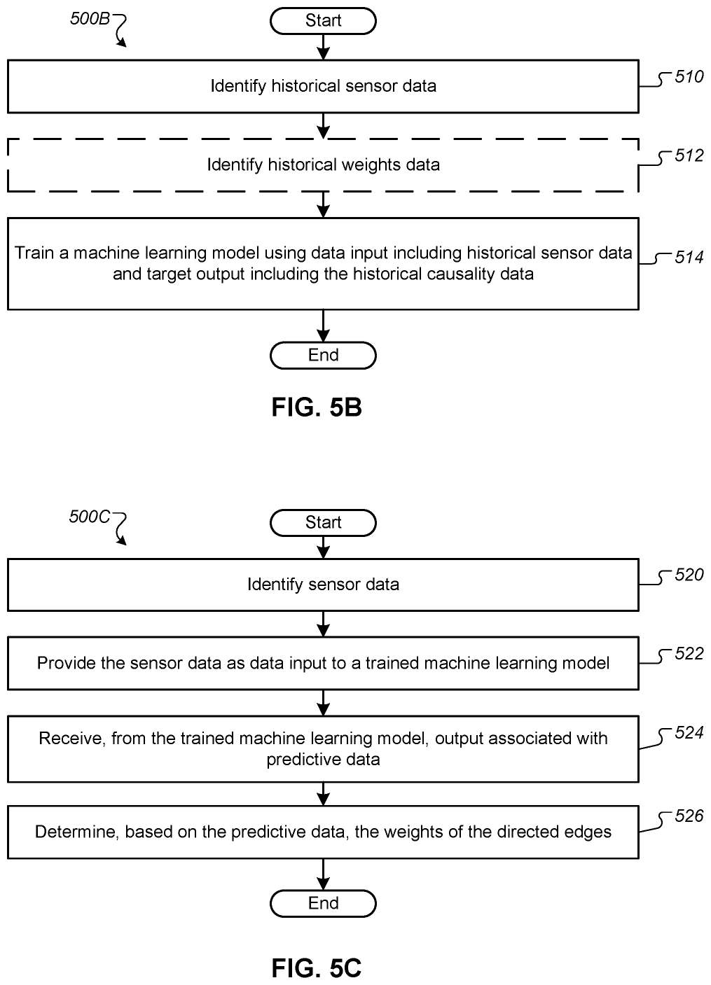

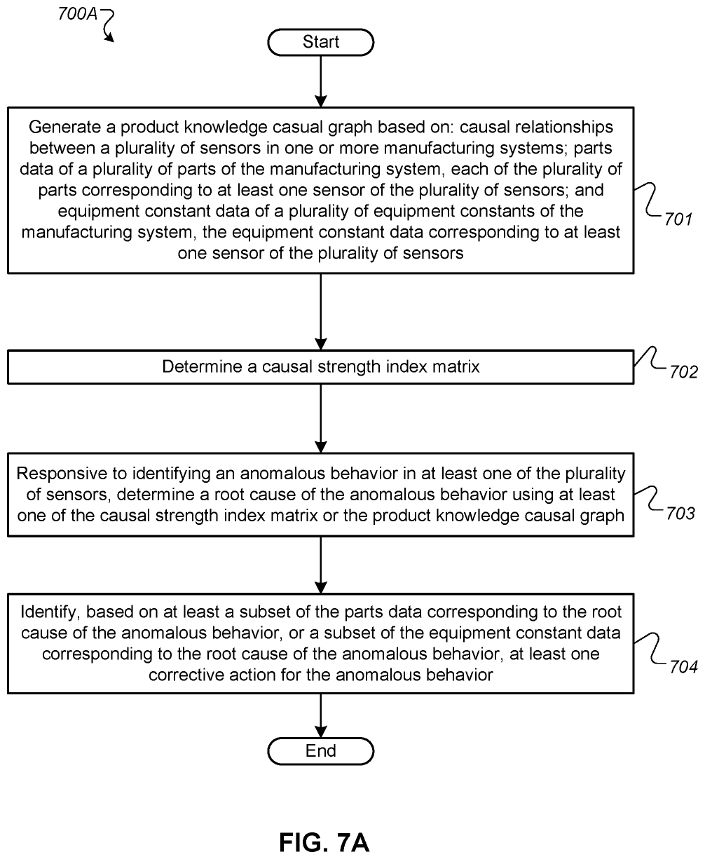

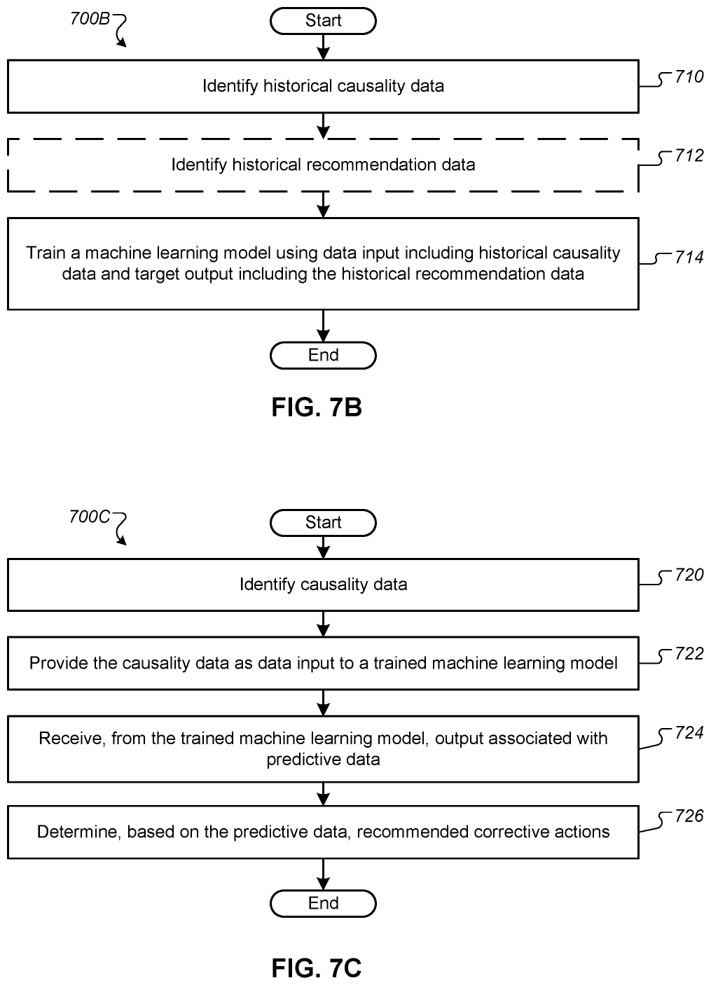

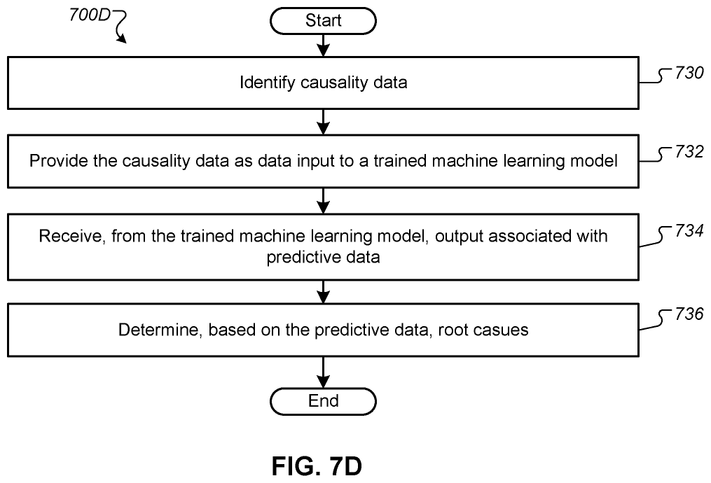

FIG. 1 is a block diagram illustrating an exemplary system 100 (exemplary system architecture), according to certain embodiments. The system 100 (e.g., via corrective action component 122 and/or predictive component 114) can perform the methods described herein (e.g., methods 500A-C of FIGS. 5A-C and methods 700A-D of FIGS. 7A-D). The system 100 includes a client device 120, manufacturing equipment 124, sensors 126, metrology equipment 128, a predictive server 112, and a data store 140. In some embodiments, the predictive server 112 is part of a predictive system 110. In some embodiments, the predictive system 110 further includes server machines 170 and 180. In some embodiments, the manufacturing equipment may include parts 125 and equipment constants 127.

In some embodiments, one or more of the client device 120, manufacturing equipment 124, sensors 126, metrology equipment 128, predictive server 112, data store 140, server machine 170, and/or server machine 180 are coupled to each other via a network 130 for generating predictive data 160 to perform residual-based adjustment of film deposition parameters during substrate manufacturing. In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the client device 120 includes a computing device such as Personal Computers (PCs), laptops, mobile phones, smart phones, tablet computers, netbook computers, etc. In some embodiments, the client device 120 includes a corrective action component 122. In some embodiments, the corrective action component 122 may also be included in the predictive system 110 (e.g., machine learning processing system). In some embodiments, the corrective action component 122 is alternatively included in the predictive system 110 (e.g., instead of being included in client device 120). Client device 120 includes an operating system that allows users to one or more of consolidate, generate, view, or edit data, provide directives to the predictive system 110 (e.g., machine learning processing system), etc.

In some embodiments, corrective action component 122 receives one or more of user input (e.g., via a Graphical User Interface (GUI) displayed via the client device 120), sensor data 142, causality data 172, performance data 152, recommendation data 132, parts data 145, equipment constants data 147, etc. In some embodiments, sensor data 142 may be data collected by sensors 126, metrology equipment 128, etc. In some embodiments, parts data 145 may include a certificate of acceptance. In some embodiments, the corrective action component 122 transmits data (e.g., user input, sensor data 142, performance data 152, causality data 172, parts data 145, equipment constants data 147, recommendation data 132, etc.) to the predictive system 110, receives predictive data 160 from the predictive system 110, determines a recommended corrective action based on the predictive data 160, and issues the recommended corrective action and/or causes the corrective action to be implemented. In some embodiments, the corrective action component 122 transmits data (e.g., user input, sensor data 142, performance data 152, causality data 172, etc.) to the predictive system 110, receives predictive data 160 from the predictive system 110, determines multiple ranked recommended corrective actions based on the predictive data 160, and issues the ranked recommended corrective actions and/or causes a selected corrective action to be implemented.

In some embodiments, the corrective action component 122 stores data (e.g., user input, sensor data 142, performance data 152, causality data 172, recommendation data 132, parts data 145, equipment constants data 147, etc.) in the data store 140 and the predictive server 112 retrieves the data from the data store 140. In some embodiments, the predictive server 112 stores output (e.g., predictive data 160) of the trained machine learning model 190 in the data store 140 and the client device 120 retrieves the output from the data store 140. In some embodiments, the corrective action component 122 receives an indication of recommended corrective action(s) (e.g., based on predictive data 160) from the predictive system 110 and causes issuance of the recommended corrective action(s) and/or performance of the corrective action(s).

Manufacturing equipment 124 can produce products, such as substrates, wafers, semiconductors, electronic devices, etc., following a recipe or performing runs over a period of time. Manufacturing equipment 124 can include a processing chamber. Processing chambers can be adapted to carry out any number of processes on substrates. A same or different substrate processing operation can take place in each processing chamber or substrate processing area. Processing chambers can include one or more sensors (e.g., sensors 126) configured to capture data for a chamber and/or substrate before, after, or during a substrate processing operation. In some embodiments, the one or more sensors can be configured to capture data associated with the environment within a processing chamber before, after, or during the substrate processing operation. For example, the one or more sensors can be configured to capture pressure data, temperature data, radio frequency (RF) power data, arcing data, gas concentration data, and/or the like during a substrate processing operation.

In some embodiments, high sampling rates and individual subsystem recipes (e.g., specialized recipes) may be used to generate the causal knowledge graph (e.g., DAG). Specialized recipes (e.g., macros) can help in learning causal graphs. In some embodiments, a processing device may use specialized recipes to detect within a sub-system a cause-effect relationship or to detect across sub-systems cause-effect relationships. In some embodiments, the processing device changes a single parameter. In some embodiments, the change may be a step-change or a ramped-change. In some embodiments, the processing device may induce a sinusoid (Bode engine). In some embodiments, the changes are made to a single parameter or setpoint. In some embodiments, multiple parameters or setpoints may be changed concurrently. In some embodiments, the sampling rates (true sampling rates of the sensor) are high sampling rates. In some embodiments, the true sampling rate data may be down sampled. In some embodiments, the true sampling rate data may be up-sampled.

In some embodiments, a processing chamber can include metrology equipment (e.g., metrology equipment 128) and/or sensors (e.g., sensors 126) configured to generate in-situ metrology measurement values (e.g., metrology data) and/or sensor measurement values (e.g., sensor data) during a process performed at processing chamber. In some embodiments, metrology equipment 128 is a subset of sensors 126 and can be included as part of the manufacturing equipment 124. In some embodiments, metrology measurement values and/or sensor measurement values may be a subset of sensor data 142 and/or performance data 152. The metrology equipment and/or sensors can be operatively coupled to the system controller. In some embodiments, the sensors can be configured to generate a sensor measurement value (e.g., a temperature) for a processing chamber during particular instances of a wafer manufacturing process.

Manufacturing equipment 124 can perform a process on a substrate (e.g., a wafer, etc.) at the processing chamber. Manufacturing equipment 124 may include parts 125 and equipment constants 127. Examples of substrate processes include a deposition process to deposit one or more layers of film on a surface of the substrate, an etch process to form a pattern on the surface of the substrate, etc. Manufacturing equipment 124 can perform each process according to a process recipe. A process recipe defines a particular set of operations to be performed on the substrate during the process and can include one or more settings associated with each operation. For example, a deposition process recipe can include a temperature setting for the processing chamber, a pressure setting for the processing chamber, a flow rate setting for a precursor for a material included in the film deposited on the substrate surface, etc.

In some embodiments, manufacturing equipment 124 includes sensors 126 that are configured to generate data associated with a manufacturing system 100. For example, a processing chamber can include one or more of a temperature sensor, pressure sensor, flow sensor, optical sensor, position sensor, gas sensor, humidity sensor, RF power sensor, vibration sensor, electrical sensor, ionization sensor, radiation sensor, and/or the like. Such sensors can be configured to generate one or more of a temperature measurement, pressure measurement, flow measurement, optical measurement, position measurement, gas measurement, humidity measurement, RF power measurement, vibration measurement, electrical measurement, and/or the like associated with the processing chamber and/or a substrate before, during, and/or after a process (e.g., a deposition process).

In some embodiments, manufacturing equipment 124 include metrology equipment 128 that are configured to generate data associated with manufacturing system 100 and/or substrates produced by manufacturing system 100. For example, a processing chamber can include one or more of an optical emission spectroscopy tool, an x-ray fluorescence (XRF) tool, an energy dispersive x-ray spectroscopy (EDS) tool, and/or the like. Such metrology equipment can be configured to generate one or more of a spatial measurement, dimensional measurement, optical measurement, position measurement, spectral measurement, radiation measurement, and/or the like associated with a substrate before, during, and/or after a manufacturing process.

In some embodiments, the predictive server 112, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 includes a predictive component 114. In some embodiments, the predictive component 114 identifies (e.g., receives from the client device 120, retrieves from the data store 140) sensor data 142 (e.g., sensor values, expected sensor values, metrology data, etc.), parts data 145, and/or equipment constant data 147 and generates predictive data 160 associated with recommendation of one or more corrective actions (e.g., cleaning, maintenance, tool shutdown, repair, calibration, updating of recipes, updating of operation parameters, updating of process operation parameters, etc.). In some embodiments, predictive component ranks the recommended corrective actions based on a corresponding severity value of a corresponding root cause (e.g., a ranked root cause).

In some embodiments, the predictive component 114 uses one or more trained machine learning models 190 to determine the predictive data 160. In some embodiments, trained machine learning model 190 is trained using historical sensor data 144 (including historical metrology data) and historical causality data 174 (e.g., historical weights data). In some embodiments, the predictive system 110 (e.g., predictive server 112, predictive component 114) generates predictive data 160 using supervised machine learning (e.g., supervised data set, historical sensor data 144 labeled with historical causality data 174, etc.). In some embodiments, the predictive system 110 generates predictive data 160 using semi-supervised learning (e.g., semi-supervised data set, causality data 172 is a predictive percentage, etc.). In some embodiments, the predictive system 110 generates predictive data 160 using unsupervised machine learning (e.g., unsupervised data set, clustering, clustering based on historical sensor data 144, etc.).

In some embodiments, the manufacturing equipment 124 (e.g., deposition chamber, cluster tool, wafer backgrind systems, wafer saw equipment, die attach machines, wirebonders, die overcoat systems, molding equipment, and/or the like) is part of a substrate processing system (e.g., wafer manufacturing system, integrated processing system, etc.).

In some embodiments, the manufacturing equipment 124 may include various interconnected parts 125 (e.g., components). Manufacturing equipment 124, including parts 125, can aid in the production of semiconductor devices. Individual parts within the manufacturing system may benefit from adherence to specific specifications and requirements to ensure quality and consistency of manufacturing. In some embodiments, sensors 126 may continuously monitor manufacturing equipment 124 and associated processing parameters. In some embodiments, equipment constants 127 (e.g., system constants such as timeout settings, calibration values, or operational thresholds, etc.) may be associated with sensors 126 and/or parts 125. Equipment constants 127 may determine how the manufacturing equipment 124 and/or parts 125 function, impacting the data collected by sensors 126, and potentially leading to anomalous sensors when equipment constants 127 are miscalibrated or misconfigured. Properly configuring and maintaining these constants benefits the performance of manufacturing equipment 124 and/or parts 125, helping to achieve consistency, efficiency, and product quality in semiconductor manufacturing.

Parts 125 may include one or more of etchers, deposition tools, diffusion furnaces, rapid thermal annealers (RTA), photolithography equipment, vacuum pumps, gas cabinets, gas lines, temperature controllers, heaters and chillers, pressure controllers, pressure relief valves, RF generators, source matches, RF cables, waveguides, antennas, spectrometers, spectrographs, optical fiber cables, laser sources, photodetectors, robot arms, particle counters, temperature control units, chemical exhaust systems, chemical dispensing systems, electrical panels, power distribution units, exhaust and ventilation, and/or the like.

Equipment constants 127 may include one or more timeout settings, stability settings, tolerance and limit settings, trigger settings, calibration constants, control parameters, filter settings, sampling and measurement constants, safety and emergency settings, communication parameters, calibration and reference values, temperature compensation constants, timing constants, threshold levels, resolution settings, conversion constants, geometry and positioning constants, and/or the like. For example, equipment constants 127 may include more than one of an RF analyzer timeout, monitor timeout, tool timeout, RF analyzer stable time, equipment warm-up time, settling time, check tolerance, check limit, reference check limit, intensity fault limit, voltage tolerance, trigger threshold, trigger delay, trigger hysteresis, calibration factors, compensation values, offset corrections, gain control, bias voltage, frequency offset, phase offset, power level settings, bandwidth, cutoff frequency, filter order, sampling rate, integration time, measurement resolution, emergency shutdown threshold, overheat protection limit, safety interlock settings, data transfer rate, baud rate, communication protocol settings, reference voltage, reference current, reference temperature, temperature coefficient, temperature compensation factors, clock frequency, time delay, time interval, voltage threshold, current threshold, signal-to-noise ratio threshold, image resolution, data bit depth, analog-to-digital converter (ADC) gain, digital-to-analog converter (DAC) scaling, position calibration factors, lens distortion corrections, etc.

The manufacturing equipment 124 includes one or more of a controller, an enclosure system (e.g., substrate carrier, front opening unified pod (FOUP), autoteach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers, a robot arm (e.g., disposed in the transfer chamber, disposed in the front interface, etc.), and/or the like. In some embodiments, the manufacturing equipment 124 includes components of substrate processing systems. In some embodiments, the sensor data 142 (including metrology data) of a processing chamber or a substrate, results from the processing chamber or substrate undergoing one or more processes performed by components of the manufacturing equipment 124 (e.g., deposition, etching, heating, cooling, transferring, processing, flowing, etc.).

In some embodiments, the sensors 126 provide sensor data 142 (e.g., sensor values, such as historical sensor values and current sensor values) of the processing chamber or of a substrate processed by manufacturing equipment 124.

In some embodiments, the sensors 126 include one or more of a metrology tool such as ellipsometers (used to determine the properties and surfaces of thin films by measuring material characteristics such as layer thickness, optical constants, surface roughness, composition, and optical anisotropy), ion mills (used to prepare heterogeneous bulk materials when wide areas of material are to be uniformly thin), capacitance versus voltage (C-V) systems (used to measure the C-V and capacitance versus time (C-t) characteristics of semiconductor devices), interferometers (used to measure distances in terms of wavelength, and to determine wavelengths of particular light sources), source measure units (SME) magnetometers, optical and imaging systems, profilometers, wafer probers (used to test a semiconductor wafer before it is separated into individual dies or chips), imaging stations, critical-dimension scanning electron microscope (CD-SEM, used to ensure the stability of the manufacturing process by measuring critical dimensions of substrates), reflectometers (used to measure the reflectivity and radiance from a surface), resistance probes (used to measure the resistivity of thin-films), resistance high-energy electron diffraction (RHEED) system (used to measure or monitor crystal structure or crystal orientation of epitaxial thin-films of silicon or other materials), X-ray diffractometers (used to unambiguously determine crystal structure, crystal orientation, film thickness and residual stress in silicon wafers, epitaxial films, or other substrates), and/or the like.

In some embodiments, the sensor data 142 is used for equipment health, system health (e.g., a system health factor index), and/or product health (e.g., product quality). In some embodiments, the sensor data 142 is received over a period of time.

In some embodiments, sensors 126 and/or metrology equipment 128 provide sensor data 142 including one or more of morphology data, size attribute data, dimensional attribute data, image data, scanning electron microscope (SEM) images, energy dispersive x-ray (EDX) images, defect distribution data, spatial location data, elemental analysis data, wafer signature data, chip layer, chip layout data, edge data, grey level data, signal to noise data, temperature data, spacing data, electrical current data, power data, voltage data, and/or the like. In some embodiments, sensor data includes morphology data, size attribute data, dimensional attribute data, SEM images, EDX images, defect distribution data, chip layout data, grey level data, signal to noise data, and/or the like.

In some embodiments, the sensor data 142 (e.g., historical sensor data 144, current sensor data 146, etc.) is processed (e.g., by the client device 120 and/or by the predictive server 112). In some embodiments, processing of the sensor data 142 includes generating features. In some embodiments, the features are a pattern in the sensor data 142 (e.g., slope, width, height, peak, etc.) or a combination of values from the sensor data 142 (e.g., power derived from voltage and current, etc.). In some embodiments, the sensor data 142 includes features that are used by the predictive component 114 for obtaining predictive data 160.

In some embodiments, the metrology equipment 128 is used to determine metrology data corresponding to the interior (e.g., surfaces) of the processing chamber or to substrates produced by the manufacturing equipment 124 (e.g., substrate processing equipment). In some examples, after the manufacturing equipment 124 processes substrates, the metrology equipment 128 is used to inspect portions (e.g., layers) of the substrates and/or the interior of the processing chamber. In some embodiments, the metrology equipment 128 performs scanning acoustic microscopy (SAM), ultrasonic inspection, x-ray inspection, and/or computed tomography (CT) inspection. In some embodiments, sensor data 142 includes sensor data from sensors 126 and/or metrology data from metrology equipment 128. Sensor data 142 may include sensor data from the sensors 126 and causality data 172 may be based on sensor data 142 from the sensors 126. Sensor data 142 may include sensor data from a first subset of the sensors 126 and causality data 172 may be based on sensor data 142 from a second subset of the sensors 126.

In some embodiments, causality data 172 may be associated with a causal relationship between a pair of sensors of sensors 126. For example, causality data 172 may be sensor data of processing chambers or substrates that have undergone a recipe and/or the processing operations of the recipe. In some embodiments, causality data may include a severity value corresponding to a rank of a root cause indicating the acuteness of the root cause in the relation of the root cause to an anomalous sensor.

In some embodiments, the sensor data 142 may be derived from sensor data and/or metrology data. Sensor data may be data describing conditions and characteristics inside a processing chamber. Metrology data may be a subset of sensor data and describe conditions and characteristics inside a processing chamber as well as conditions and characteristics of a substrate.

In some embodiments, recommendation data 132 may be associated with recommended corrective actions (e.g., proposed actions to correct anomalous behavior of manufacturing equipment 124, parts 125, etc.) and/or root causes of an anomalous sensor of a manufacturing system (e.g., used for root cause tracing). In some embodiments, recommendation data 132 is provided by a processing device using a trained machine learning model (e.g., model 190). In some embodiments, model 190 determines one or more root causes of an anomalous behavior (e.g., using causality data 172). In some embodiments, model 190 determines recommendation data 132 and identifies one or more corrective actions to correct an anomalous behavior using the causality data 172 (e.g., the product knowledge causal graph, the causal strength index matrix, etc.).

In some embodiments, recommendation data, may be associated with causality data. For example, a recommended corrective action may be issued based on a root cause of an anomalous behavior, the root cause being determined based on causality data (e.g., using a product knowledge causal graph). In some embodiments, the product knowledge causal graph and/or causal strength index matrix may include indications of anomalous sensors/nodes in the product knowledge causal graph and/or causal strength index matrix for root cause tracing and corrective action identification. For example, when an anomalous behavior is detected in at least one of the plurality of nodes (sensors) of the product knowledge causal graph the anomalous nodes may be flagged as anomalous. The product knowledge causal graph (e.g., with the flagged node) may then be given as input to a trained machine learning model. One or more outputs of the trained machine learning model may indicate a root cause and/or a corrective action (e.g., for the anomalous behavior). A more detailed explanation of methods used to detect anomalous behaviors in a manufacturing system will be given later in the description.

In some embodiments, performance data 152 may be associated with a system health factor index of system 100. Performance data 152 may include system health factor index data (e.g., system health factor index values, anomalous sensors data, etc.) For example, performance data 152 may be health factor index values of processing chambers or the entire system 100. In some embodiments, the performance data 152 may be derived from sensor data 142 of sensors 126, metrology data of metrology equipment 128, and causality data 172.

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of sensor data 142 (including metrology data), performance data 152 (e.g., system health factor index values), causality data 172, recommendation data 132, parts data 145, equipment constants data 147, and/or predictive data 160.

Causality data 172 may include weights data (e.g., strength of a causal relationship between two or more variables, weight values of directed edges of a DAG, etc.), causal strength index matrix value data, causal graph data (e.g., causal graph structural data, node criticality data, etc.), DAG data (e.g., DAG structural data, node criticality data, etc.), importance data (e.g., importance values of a DAG node), criticality data (e.g., criticality data of a DAG node), severity data (e.g., the severity of a causal relationship between two or more variables/nodes), causal strength index data, etc.

In some embodiments, the predictive data 160 is associated with determining causality data 172, severity data, and/or weights data (e.g., weights values of causal relationship, weights of directed edges, etc.). In some embodiments, weights data is associated with one or more of a causal strength index matrix, a causal graph, training a machine learning model using data input including historical sensor values and target output including historical causality data, using a trained machine learning model to receive output associated with predictive data, determining weights of directed edges, determining weights data, machine learning modification, and/or the like.

In some embodiments, data store 140 can be configured to store data that is not accessible to a user of the manufacturing system. For example, process data, spectral data, contextual data, etc. obtained for a substrate being processed at the manufacturing system and/or a substrate being processed at the manufacturing system is not accessible to a user (e.g., an operator) of the manufacturing system. In some embodiments, all data stored at data store 140 can be inaccessible by the user of the manufacturing system. In some embodiments, a portion of data stored at data store 140 can be inaccessible by the user while another portion of data stored at data store 140 can be accessible by the user. In some embodiments, one or more portions of data stored at data store 140 can be encrypted using an encryption mechanism that is unknown to the user (e.g., data is encrypted using a private encryption key). In some embodiments, data store 140 can include multiple data stores where data that is inaccessible to the user is stored in one or more first data stores and data that is accessible to the user is stored in one or more second data stores.

Sensor data 142 includes historical sensor data 144 and current sensor data 146. In some embodiments, sensor data 142 (e.g., sensor data) may include RF power of a substrate processing operation, a spacing value of a substrate processing operation, a gas flow value of a substrate processing operation, pressure data, temperature data, power data, and/or the like. Sensor data 142 may further include temperature values, pressure values, flow values, optical values, humidity values, RF power values, electrical values, radiation values, and/or the like. In some embodiments, at least a portion of the sensor data 142 is from sensors 126.

In some embodiments, sensor data 142 includes metrology data collected by metrology equipment 128. For example, optical emission spectroscopy (OES) is measured using an OES tool and may measure the OES for both the chamber and/or the substrate in a manufacturing system.

Performance data 152 includes historical performance data 154 and current performance data 156. Performance data 152 may be indicative of a system health factor index value. For example, the system health factor index value may be calculated based on a number of anomalous sensors detected in the manufacturing system and the corresponding criticality values of the anomalous sensors and is normalized using the weights of the plurality of directed edges corresponding to the anomalous sensors.

In some embodiments, an anomalous sensor is a sensor and/or metrology tool that is collecting anomalous data (e.g., measurements that are outside the expected or normal range for a particular parameter). The system health factor index value indicates the health of the system. In some embodiments a high system health factor index means the system is relatively healthy and a low system factor index means the system is unhealthy. In some embodiments, when the system health factor index value is high and indicates that the system is healthy, a recommended corrective action may not be issued for a detected anomalous sensor or sensors. This is because the causal effect of such anomalous sensors does not have enough weight (e.g., strong causal effect on the outputs of the system), thus a recommended corrective action is not required. In some embodiments, such sensors may have a low criticality.

On the other hand, when the anomalous sensors have higher weights and affect the outputs of the system more significantly, the system health factor index value may be lower (e.g., the system is unhealthy). Under such circumstances a low system health factor index value will cause a recommended corrective action to be issued. In some embodiments, this is because the anomalous sensors have high criticality (e.g., significantly affect the outputs of the system). In some embodiments, the system health factor index may be a percentage value. As the value approaches 100% the system operates in a more matched and expected state.

In some embodiments, historical data includes one or more of historical sensor data 144 and/or historical causality data 174 (e.g., at least a portion for training the machine learning model 190). Current data includes one or more of current sensor data 146 and/or current causality data 176 (e.g., at least a portion to be input into the trained machine learning model 190 subsequent to training the model 190 using the historical data). In some embodiments, the current data is used for retraining the trained machine learning model 190.

Causality data 172 includes historical causality data 174 and current causality data 176. Causality data 172 may be indicative of whether a change in first variable (e.g., a change detected by a sensor leading to a change in sensor data) causes a change in a second variable, the strength (e.g., a weight) of that causal relationship, and a direction of the causal relationship (e.g., X causes Y, but Y does not cause X). Causality data 172 may be indicative of relationships found between variables of a manufacturing system using at least one of Granger causality, transfer entropy measures, cross-entropy measures, causality tests, partial directed coherence, linear and non-linear conditional independence tests, or the like. In some embodiments, a time series X is said to Granger-cause Y if it can be shown through a series of tests on lagged values of X (e.g., that those X values provide statistically significant information about future values of Y). In some embodiments, transfer entropy from a process X to another process Y is the amount of uncertainty reduced in future values of Y by knowing the past values of X given past values of Y. In some embodiments, a causality test may confirm, for example, which delivered power causes reflected power, as expected by a subject matter expert.

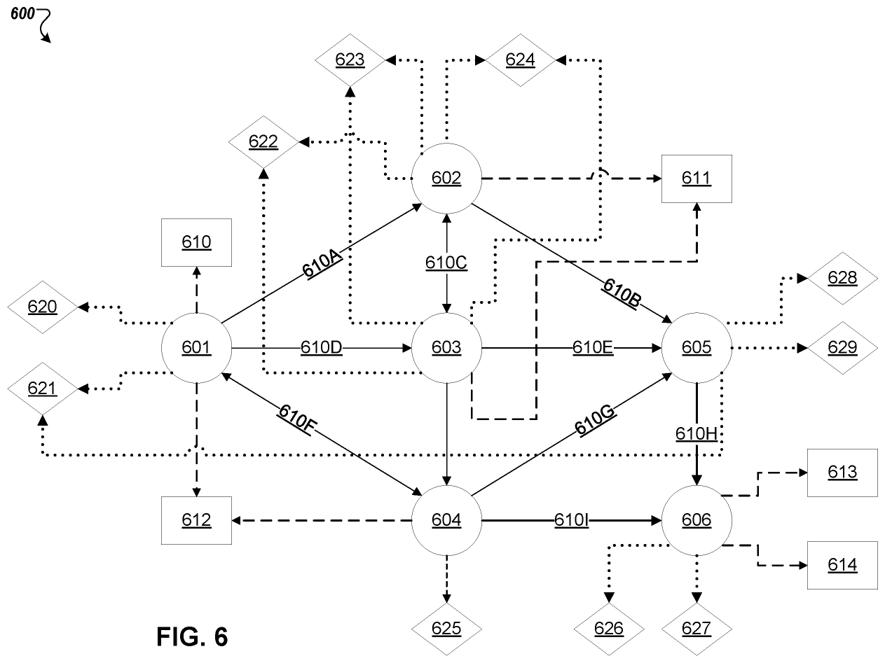

In some embodiments, causality data 172 includes product knowledge causal graphs (e.g., product knowledge causal graph 600 of FIG. 6) and/or causal strength index matrices. In some embodiments, causal graphs (e.g., product knowledge causal graphs) and/or causal strength index matrices include indications of anomalous sensors/nodes in the causal graph and/or causal strength index matrices (e.g., for root cause tracing and corrective action identification.) For example, when an anomalous behavior is detected in at least one of the plurality of sensors, the node representing the sensor may be flagged as anonymous and a root cause of the anomalous behavior may be determined using the causal strength index matrix or the causal graph. A corrective action for the anomalous may be identified, based on at least a subset of parts data corresponding to the root cause of the anomalous behavior, or a subset of equipment constant data corresponding to the root cause of the anomalous behavior.

Recommendation data 132 may include indications of recommended corrective actions, root cause data (e.g., used for determining recommended corrective actions), etc.

In some embodiments, the predictive data 160 is associated with determining recommendation data 132. In some embodiments, recommendation data 132 is associated with one or more of recommended corrective actions, roots causes, training a machine learning model using data input including historical sensor values and target output including historical recommendation data, using a trained machine learning model to receive output associated with predictive data, determining recommended corrective actions, determining root causes, machine learning modification, and/or the like.

Parts data 145 may include parts specifications, parts serial numbers, batch numbers, part numbers, country of origin, site number, manufacturing equipment data, component data, product data, certificates of acceptance, etc. In some embodiments, parts data may be static data. In some embodiments, static data may be unchanging data or values, and may be used as reference or configuration data (e.g., parts data in a manufacturing system that remain constant and do not vary over time).

In some embodiments, parts data may include numerical data (e.g., part specification data, values, etc.) and/or sematic data (e.g., text data included in a certificate of acceptance). In some embodiments, a user may leave notes in a certificate of acceptance. Such text data may include semantic data.

Equipment constants data 147 may include equipment constants, equipment constant values, equipment constants settings, equipment constant configurations, etc. In some embodiments, equipment constant data may be static data. For example, an equipment constant may not be tunable and remains the same. In some embodiments, static data may be unchanging data or values, and may be used as reference or configuration data (e.g., equipment constants in a manufacturing system that remain constant and do not vary over time). In some embodiments, equipment constant data may be dynamic data.

In some embodiments, historical data includes one or more of historical sensor data 144, historical causality data 174, historical recommendations data 134, and/or historical performance data 154 (e.g., at least a portion for training the machine learning model 190). Current data includes one or more of current sensor data 146, current causality data 176, current recommendations data 136, and/or current performance data 156 (e.g., at least a portion to be input into the trained machine learning model 190 subsequent to training the model 190 using the historical data). In some embodiments, the current data is used for retraining the trained machine learning model 190.

In some embodiments, the predictive data 160 is to be used to determine the weights of the directed edges (e.g., directed edges of a DAG). In some embodiments, the predictive data 160 is to be used to determine the root causes of anomalous sensors (e.g., in a product knowledge causal graph). In some embodiments, the predictive data 160 is to be used to determine corrective actions (e.g., for anomalous sensors in a product knowledge causal graph).

By providing sensor data 142 to model 190, receiving predictive data 160 from the model 190, and determining the weights of the directed edges based on the predictive data 160, system 100 has the technical advantage of avoiding the cost of recommending misguided corrective actions, wasted time, wasted energy, wasted products, etc. Further, by providing causality data 172 to model 190, receiving predictive data 160 from the model 190, and determining root causes and/or recommended corrective actions based on the predictive data 160, system 100 has the technical advantage of avoiding the cost of recommending misguided corrective actions, wasted time, wasted energy, wasted products, etc.

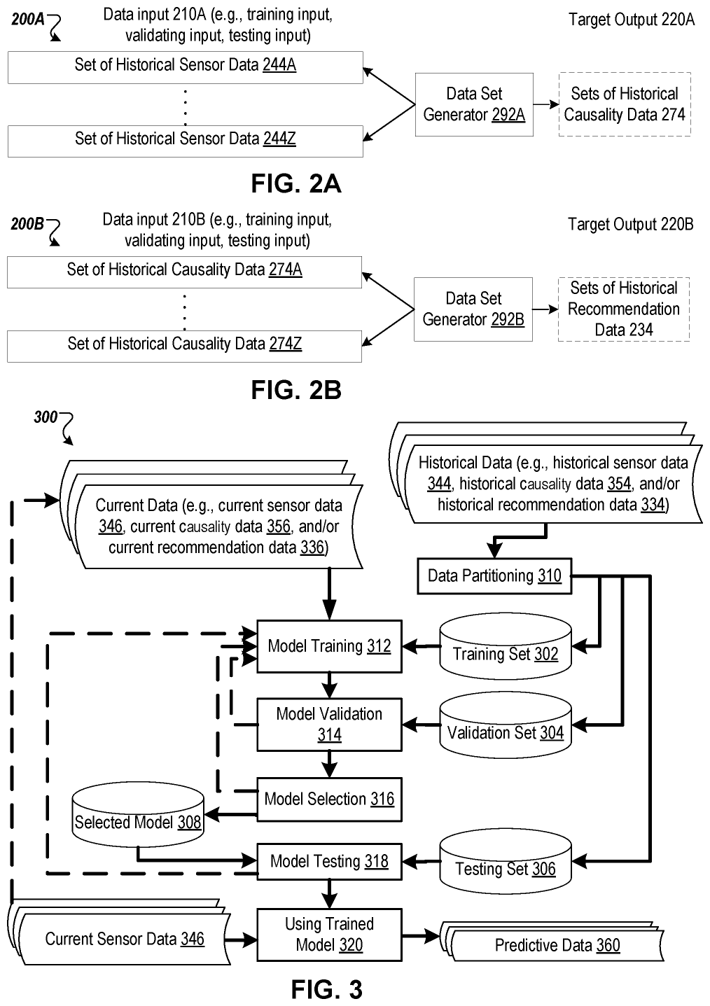

In some embodiments, predictive system 110 further includes server machine 170 and server machine 180. Server machine 170 includes a data set generator 178 that is capable of generating data sets (e.g., a set of data inputs and a set of target outputs) to train, validate, and/or test a machine learning model(s) 190. The data set generator 178 has functions of data gathering, compilation, reduction, and/or partitioning to put the data in a form for machine learning. In some embodiments (e.g., for small datasets), partitioning (e.g., explicit partitioning) for post-training validation is not used. Repeated cross-validation (e.g., 5-fold cross-validation, leave-one-out-cross-validation) may be used during training where a given dataset is in-effect repeatedly partitioned into different training and validation sets during training. A model (e.g., the best model, the model with the highest accuracy, etc.) is chosen from vectors of models over automatically-separated combinatoric subsets. In some embodiments, the data set generator 178 may explicitly partition the historical data (e.g., historical sensor data 144 and corresponding historical causality data 174, historical causality data corresponding to historical recommendations data 134, etc.) into a training set (e.g., sixty percent of the historical data), a validating set (e.g., twenty percent of the historical data), and a testing set (e.g., twenty percent of the historical data). Some operations of data set generator 178 are described in detail below with respect to FIGS. 2A-B, according to some embodiments. In some embodiments, the predictive system 110 (e.g., via predictive component 114) generates multiple sets of features (e.g., training features).

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general-purpose computer system, or a dedicated machine), firmware, microcode, or a combination thereof. The training engine 182 is capable of training a machine learning model 190 using one or more sets of features associated with the training set from data set generator 178. In some embodiments, the training engine 182 generates multiple trained machine learning models 190, where each trained machine learning model 190 corresponds to a distinct set of parameters of the training set (e.g., sensor data 142, causality data 172, etc.) and corresponding responses (e.g., causality data 172, recommendations data 132, etc.). In some embodiments, multiple models are trained on the same parameters with distinct targets for the purpose of modeling multiple effects. In some examples, a first trained machine learning model was trained using sensor data 142 from all sensors 126 (e.g., sensors 1-5), a second trained machine learning model was trained using a first subset of the sensor data (e.g., from sensors 1, 2, and 4), and a third trained machine learning model was trained using a second subset of the sensor data (e.g., from sensors 1, 3, 4, and 5) that partially overlaps the first subset of features.

The validation engine 184 is capable of validating a trained machine learning model 190 using a corresponding set of features of the validation set from data set generator 178. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 evaluates and flags (e.g., to be discarded) trained machine learning models 190 that have an accuracy that does not meet a threshold accuracy. In some embodiments, the selection engine 185 is capable of selecting one or more trained machine learning models 190 that have an accuracy that meets a threshold accuracy or the model that has the highest accuracy of the trained machine learning models 190.

The testing engine 186 is capable of testing a trained machine learning model 190 using a corresponding set of features of a testing set from data set generator 178. For example, a first trained machine learning model 190 that was trained using a first set of features of the training set is tested using the first set of features of the testing set. The testing engine 186 determines a trained machine learning model 190 that has the highest accuracy of all the trained machine learning models based on the testing sets.

In some embodiments, the machine learning model 190 (e.g., used for classification) refers to the model artifact that is created by the training engine 182 using a training set that includes data inputs and corresponding target outputs (e.g., correctly classifies a condition or ordinal level for respective training inputs). Patterns in the data sets can be found that map the data input to the target output (the correct classification or level), and the machine learning model 190 is provided mappings that captures these patterns. In some embodiments, the machine learning model 190 uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. Non probabilistic methods may also be used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model 190 is a multi-variate analysis (MVA) regression model.

Predictive component 114 provides current sensor data 146 (e.g., as input) to the trained machine learning model 190 and runs the trained machine learning model 190 (e.g., on the input to obtain one or more outputs). The predictive component 114 is capable of determining (e.g., extracting) predictive data 160 from the trained machine learning model 190 and determines (e.g., extracts) uncertainty data that indicates a level of credibility that the predictive data 160 corresponding to current causality data 176 (e.g., weights data). In some embodiments, the predictive component 114 is capable of determining predictive data 160 from the trained machine learning model 190 and determines uncertainty data that indicates a level of credibility that the predictive data 160 corresponding to current recommendation data 136 (e.g., root cause determination, recommended corrective action, etc.). In some embodiments, the predictive component 114 or corrective action component 122 uses the uncertainty data (e.g., uncertainty function or acquisition function derived from uncertainty function) to decide whether to use the predictive data 160 to perform corrective action(s) or whether to further train the model 190.

For purpose of illustration, rather than limitation, aspects of the disclosure describe the training of one or more machine learning models 190 using historical data (e.g., prior data, historical sensor data 144, historical recommendation data 134, and historical causality data 174) and providing current data into the one or more trained probabilistic machine learning models 190 to determine predictive data 160. In other implementations, a heuristic model or rule-based model is used to determine predictive data 160 (e.g., without using a trained machine learning model). In other implementations non-probabilistic machine learning models may be used. Predictive component 114 monitors historical sensor data 144, historical recommendation data 134, and historical causality data 174. In some embodiments, any of the information described with respect to data inputs 210A of FIG. 2A and data inputs 210B of FIG. 2B are monitored or otherwise used in the heuristic or rule-based model.

In some embodiments, the functions of client device 120, predictive server 112, server machine 170, and server machine 180 are to be provided by a fewer number of machines. For example, in some embodiments, server machines 170 and 180 are integrated into a single machine, while in some other embodiments, server machine 170, server machine 180, and predictive server 112 are integrated into a single machine. In some embodiments, client device 120 and predictive server 112 are integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 determines corrective actions based on the predictive data 160. In another example, client device 120 determines the predictive data 160 based on data received from the trained machine learning model. In addition, the functions of a particular component can be performed by different or multiple components operating together. In some embodiments, one or more of the predictive server 112, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

Although embodiments of the disclosure are discussed in terms of determining predictive data 160 associated with the weights of the directed edges of a DAG (e.g., weights data), in some embodiments, the disclosure can also be generally applied to determining causal relationships between components of manufacturing systems. Embodiments can be generally applied to determining causal relationships based on different types of data. Further, although embodiments of the disclosure are discussed in terms of and determining predictive data 160 associated with recommended corrective actions and/or root causes for anomalous sensors of manufacturing systems, embodiments can be generally applied to determining recommended corrective actions and/or root causes based on different types of data in different types of systems.

FIGS. 2A-B depict block diagrams of example data set generators 292A-B (e.g., data set generator 178 of FIG. 1) to create data sets for training, testing, validating, etc. a model (e.g., model 190A-Z of FIG. 1), according to some embodiments. Each data set generator 292A of FIG. 2A and/or 292B of FIG. 2B may be part of server machine 170 of FIG. 1. In some embodiments, several machine learning models associated with manufacturing equipment 124 may be trained, used, and maintained (e.g., within a manufacturing facility). Each machine learning model may be associated with one of data set generators 292A-B, multiple machine learning models may share a data set generator, etc.

FIG. 2A illustrates a data set generator 292A (e.g., data set generator 178 of FIG. 1) to create data sets for a machine learning model (e.g., associated with determining weights of directed edges, methods 500A-C, etc.) (e.g., model 190 of FIG. 1), according to certain embodiments. In some embodiments, data set generator 292A is part of server machine 170 of FIG. 1. The data sets generated by data set generator 292A of FIG. 2A may be used to train a machine learning model (e.g., see FIG. 5B) to determine the weights of the directed edges of a DAG (e.g., see FIG. 5C).

In some embodiments, data set generator 292A may generate data sets for training, testing, and/or validating a generator model configured to determine weights of directed edges of a DAG. The machine learning model is provided with sets of historical sensor data 244A-Z, as data input 210A. The machine learning model may be configured to accept sensor data as input data and generate causality data as output.

Data set generator 292A (e.g., data set generator 178 of FIG. 1) creates data sets for a machine learning model (e.g., model 190 of FIG. 1). Data set generator 292A creates data sets using historical sensor data 244A-Z (e.g., historical sensor data 144 of FIG. 1) and historical causality data 274 (e.g., historical causality data 174 of FIG. 1). System 200A of FIG. 2A illustrates data set generator 292A, data inputs 210A, and target output 220A (e.g., target data).

In some embodiments, data set generator 292A generates a data set (e.g., training set, validating set, testing set) that includes one or more data inputs 210A (e.g., training input, validating input, testing input). In some embodiments, data set generator 292A does not generate target output (e.g., for unsupervised learning). In some embodiments, data set generator generates one or more target outputs 220A (e.g., for supervised learning) that correspond to the data inputs 210A. The data set may also include mapping data that maps the data inputs 210A to the target outputs 220A. Data inputs 210A are also referred to as “features,” “attributes,” or information.” In some embodiments, data set generator 292A provides the data set to the training engine 182, validation engine 184, or testing engine 186, where the data set is used to train, validate, or test the machine learning model 190 (e.g., associated with determining weights of directed edges, methods 500A-C, etc.).

In some embodiments, data set generator 292A generates the data input 210A and target output 220A. In some embodiments, data inputs 210A include one or more sets of historical sensor data 244 (e.g., chamber temperature values, chamber pressure values, etc.) (e.g., associated with determining weights of directed edges, methods 500A-C, etc.). In some embodiments, historical sensor data 244 includes one or more of sensor data from one or more types of sensors and/or metrology equipment, combination of sensor data from one or more types of sensors and/or metrology equipment, patterns from sensor data from one or more types of sensors and/or metrology equipment, and/or the like.

In some embodiments, data set generator 292A generates a first data input corresponding to a first set of historical sensor data 244A to train, validate, or test a first machine learning model and the data set generator 292A generates a second data input corresponding to a second set of historical sensor data 244B to train, validate, or test a second machine learning model (e.g., associated with determining weights of directed edges, methods 500A-C, etc.).

In some embodiments, the data set generator 292A discretizes (e.g., segments) one or more of the data input 210A or the target output 220A (e.g., to use in classification algorithms for regression problems). Discretization (e.g., segmentation via a sliding window) of the data input 210A or target output 220A transforms continuous values of variables into discrete values. In some embodiments, the discrete values for the data input 210A indicate discrete historical sensor data 144 to obtain a target output 220A (e.g., discrete historical causality data 174).

Data inputs 210A and target outputs 220A to train, validate, or test a machine learning model include information for a particular facility (e.g., for a particular substrate manufacturing facility, substrate manufacturing chamber, etc.). In some examples, historical sensor data 244 and historical causality data 274 are for the same manufacturing facility (e.g., associated with determining weights of directed edges, methods 500A-C, etc.).

In some embodiments, the information used to train the machine learning model is from specific types of manufacturing equipment 124 of the manufacturing facility having specific characteristics and allow the trained machine learning model (e.g., associated with determining weights of directed edges, methods 500A-C, etc.) to determine outcomes for a specific group of manufacturing equipment 124 based on input for current parameters (e.g., current sensor data 146) associated with one or more components sharing characteristics of the specific group. In some embodiments, the information used to train the machine learning model is for components from two or more manufacturing facilities and allows the trained machine learning model to determine outcomes for components based on input from one manufacturing facility.

In some embodiments, subsequent to generating a data set and training, validating, or testing a machine learning model 190 using the data set, the machine learning model 190 (e.g., associated with determining weights of directed edges, methods 500A-C, etc.) is further trained, validated, or tested (e.g., current causality data 176 of FIG. 1) or adjusted (e.g., adjusting weights associated with input data of the machine learning model 190, such as connection weights in a neural network).

The machine learning model processes the input to generate an output (e.g., associated with determining weights of directed edges, methods 500A-C, etc.). An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine learning model can produce.

Accordingly, the output can include one or more predictions or inferences (e.g., associated with determining weights of directed edges, methods 500A-C, etc.). For example, an output prediction or inference can include one or more weights of directed edges of a DAG, updated weights of directed edges of a DAG, predicted weights of directed edges of a DAG, and so on. Processing logic determines an error (e.g., a classification error) based on the differences between the output (e.g., predictions or inferences) of the machine learning model and target labels associated with the input training data. Processing logic adjusts weights of one or more nodes in the machine learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In some embodiments, the stopping criteria is met when at least a minimum number of data points have been processed and at least a threshold accuracy is achieved. The threshold accuracy can be, for example, 70%, 80% or 90% accuracy. In some embodiments, the stopping criterion is met if accuracy of the machine learning model has stopped improving. If the stopping criterion has not been met, further training is performed. If the stopping criterion has been met, training can be complete. Once the machine learning model is trained, a reserved portion of the training dataset can be used to test the model.

FIG. 2B illustrates a data set generator associated with determining corrective actions and root causes for manufacturing systems, according to some embodiments.

FIG. 2B illustrates a data set generator 292B (e.g., data set generator 178 of FIG. 1) to create data sets for a machine learning model (associated with determining corrective actions and root causes for manufacturing systems, methods 700A-D, etc.) (e.g., model 190 of FIG. 1), according to certain embodiments. In some embodiments, data set generator 292B is part of server machine 170 of FIG. 1. The data sets generated by data set generator 292B of FIG. 2B may be used to train a machine learning model (e.g., see FIG. 7B) to determine corrective actions for manufacturing systems (e.g., see FIG. 7C) (e.g., based on causality data, product knowledge causal graphs, causal strength index matrices, etc.). The data sets generated by data set generator 292B of FIG. 2B may be used to train a machine learning model (e.g., see FIG. 7B) to determine root causes for manufacturing systems (e.g., see FIG. 7D) (e.g., based on causality data, product knowledge causal graphs, causal strength index matrices, etc.).

In some embodiments, data set generator 292B may generate data sets for training, testing, and/or validating a generator model configured to determine root causes and/or to recommended corrective actions for manufacturing systems. The machine learning model is provided with sets of historical causality data 274A-Z, as data input 210B. The machine learning model may be configured to accept causality data as input data and generate recommendation data as output. In some embodiments, the machine learning model may be configured to accept sensor data (e.g., anomalous sensor data) and causality data as input data and generate root cause data as output.

Data set generator 292B (e.g., data set generator 178 of FIG. 1) creates data sets for a machine learning model (e.g., model 190 of FIG. 1). Data set generator 292B creates data sets using historical causality data 274 (e.g., historical causality data 174 of FIG. 1) and historical recommendation data 234 (e.g., historical recommendation data 134 of FIG. 1). System 200B of FIG. 2B illustrates data set generator 292B, data inputs 210B, and target output 220B (e.g., target data).

In some embodiments, data set generator 292B generates a data set (e.g., training set, validating set, testing set) that includes one or more data inputs 210B (e.g., training input, validating input, testing input). In some embodiments, data set generator 292B does not generate target output (e.g., for unsupervised learning). In some embodiments, data set generator generates one or more target outputs 220B (e.g., for supervised learning) that correspond to the data inputs 210B. The data set may also include mapping data that maps the data inputs 210B to the target outputs 220B. Data inputs 210B are also referred to as “features,” “attributes,” or information.” In some embodiments, data set generator 292B provides the data set to the training engine 182, validation engine 184, or testing engine 186, where the data set is used to train, validate, or test the machine learning model 190 (e.g., associated with determining corrective actions and root causes for manufacturing systems, methods 700A-D, etc.).

In some embodiments, data set generator 292B generates the data input 210B and target output 220B. In some embodiments, data inputs 210B include one or more sets of historical causality data 272B (e.g., weight values, causal connections, product knowledge causal graphs, causal strength index matrices, anomalous sensors, etc.) (e.g., associated with determining corrective actions and root causes for manufacturing systems, methods 700A-D, etc.). In some embodiments, historical causality data 274 includes one or more of causality data from one or more types of manufacturing systems and/or subsystems, combination of causality data from one or more types of manufacturing systems and/or subsystems, patterns from causality data from one or more types of manufacturing systems and/or subsystems, and/or the like.

In some embodiments, data set generator 292B generates a first data input corresponding to a first set of historical causality data 274A to train, validate, or test a first machine learning model and the data set generator 292B generates a second data input corresponding to a second set of historical causality data 274B to train, validate, or test a second machine learning model (e.g., associated with determining corrective actions and root causes for manufacturing systems, methods 700A-D, etc.).

In some embodiments, the data set generator 292B discretizes (e.g., segments) one or more of the data input 210B or the target output 220B (e.g., to use in classification algorithms for regression problems). Discretization (e.g., segmentation via a sliding window) of the data input 210B or target output 220B transforms continuous values of variables into discrete values. In some embodiments, the discrete values for the data input 210B indicate discrete historical causality data 174 to obtain a target output 220B (e.g., discrete historical recommendation data 134, etc.).

Data inputs 210B and target outputs 220B to train, validate, or test a machine learning model include information for a particular facility (e.g., for a particular substrate manufacturing system, substrate manufacturing subsystem, etc.). In some examples, historical causality data 274A and historical recommendation data 234 are for the same manufacturing facility (e.g., associated with determining corrective actions and root causes for manufacturing systems, methods 700A-D, etc.).

In some embodiments, the information used to train the machine learning model is from specific types of manufacturing equipment 124 of the manufacturing facility having specific characteristics and allow the trained machine learning model (e.g., associated with determining corrective actions and root causes for manufacturing systems, methods 700A-D, etc.) to determine outcomes for a specific group of manufacturing equipment 124 based on input for current parameters (e.g., current causality data 176) associated with one or more components sharing characteristics of the specific group. In some embodiments, the information used to train the machine learning model is for components from two or more manufacturing facilities and allows the trained machine learning model to determine outcomes for components based on input from one manufacturing facility.

In some embodiments, subsequent to generating a data set and training, validating, or testing a machine learning model 190 using the data set, the machine learning model 190 (e.g., associated with determining corrective actions and root causes for manufacturing systems, methods 700A-D, etc.) is further trained, validated, or tested (e.g., current recommendation data 136 of FIG. 1) or adjusted (e.g., adjusting determined root causes and/or recommended corrective actions associated with input data of the machine learning model 190, such as connection weights in a neural network).

In some embodiments, recommendation data, including historical recommendation data, may be associated with causality data. For example, a recommended corrective action may be issued based on a root cause of an anomalous behavior, the root cause being determined based on causality data (e.g., using a product knowledge causal graph). For example, an anomalous behavior may be detected in a node (sensor) of a causal graph and the anomalous node may be flagged as anomalous. The causal graph (e.g., with the flagged node) may then be given as input to a trained machine learning model. One or more outputs of the trained machine learning model may indicate a root cause and/or a corrective action (e.g., for the anomalous behavior).

The machine learning model processes the input to generate an output (e.g., associated with determining corrective actions and root causes for manufacturing systems, methods 700A-D, etc.). An artificial neural network includes an input layer that consists of values in a data point. The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer can be another hidden layer or an output layer. In either case, the nodes at the next layer receive the output values from the nodes at the previous layer, and each node applies weights to those values and then generates its own output value. This can be performed at each layer. A final layer is the output layer, where there is one node for each class, prediction and/or output that the machine learning model can produce.

Accordingly, the output can include one or more predictions or inferences (e.g., associated with determining corrective actions and root causes for manufacturing systems, methods 700A-D, etc.). For example, an output prediction or inference can include one or more root causes, one or more recommended corrective actions (e.g., associated with the one or more root causes), and so on. Processing logic determines an error (e.g., a classification error) based on the differences between the output (e.g., predictions or inferences) of the machine learning model and target labels associated with the input training data. Processing logic adjusts weights of one or more nodes in the machine learning model based on the error. An error term or delta can be determined for each node in the artificial neural network. Based on this error, the artificial neural network adjusts one or more of its parameters for one or more of its nodes (the weights for one or more inputs of a node). Parameters can be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters can include adjusting the weights assigned to each of the inputs for one or more neurons at one or more layers in the artificial neural network.

After one or more rounds of training, processing logic can determine whether a stopping criterion has been met. A stopping criterion can be a target level of accuracy, a target number of processed images from the training dataset, a target amount of change to parameters over one or more previous data points, a combination thereof and/or other criteria. In some embodiments, the stopping criteria is met when at least a minimum number of data points have been processed and at least a threshold accuracy is achieved. The threshold accuracy can be, for example, 70%, 80% or 90% accuracy. In some embodiments, the stopping criterion is met if accuracy of the machine learning model has stopped improving. If the stopping criterion has not been met, further training is performed. If the stopping criterion has been met, training can be complete. Once the machine learning model is trained, a reserved portion of the training dataset can be used to test the model.

FIG. 3 is a block diagram illustrating a system 300 for generating predictive data 360 (e.g., predictive data 160 of FIG. 1), according to certain embodiments. The system 300 is used to determine predictive data 360 via a trained machine learning model (e.g., associated with determining weights of directed edges, methods 500A-C, associated with determining corrective actions and root causes for manufacturing systems, methods 700A-D, etc.) (e.g., model 190 of FIG. 1).

At block 310, the system 300 (e.g., predictive system 110 of FIG. 1) performs data partitioning (e.g., via data set generator 178 of server machine 170 of FIG. 1) of the historical data (e.g., historical sensor data 344, historical causality data 354, and/or historical recommendation data 334 for model 190 of FIG. 1) to generate the training set 302, validation set 304, and testing set 306 (e.g., associated with determining weights of directed edges, methods 500A-C, associated with determining corrective actions and root causes for manufacturing systems, methods 700A-D, etc.). In some examples, the training set is 60% of the historical data, the validation set is 20% of the historical data, and the testing set is 20% of the historical data. The system 300 generates a plurality of sets of features for each of the training set, the validation set, and the testing set. In some examples, if the historical data includes features derived from 20 sensors (e.g., sensors 126 of FIG. 1, sensors of manufacturing equipment and/or metrology equipment) and 100 products (e.g., products that each correspond to sensor data from the 20 sensors), a first set of features is sensors 1-10, a second set of features is sensors 11-20, the training set is products 1-60, the validation set is products 61-80, and the testing set is products 81-100. In this example, the first set of features of the training set would be parameters from sensors 1-10 for products 1-60.

At block 312, the system 300 performs model training (e.g., via training engine 182 of FIG. 1 associated with determining weights of directed edges, methods 500A-C, associated with determining corrective actions and root causes for manufacturing systems, methods 700A-D, etc.) using the training set 302. In some embodiments, the system 300 trains multiple models using multiple sets of features of the training set 302 (e.g., a first set of features of the training set 302, a second set of features of the training set 302, etc.). For example, system 300 trains a machine learning model to generate a first trained machine learning model using the first set of features in the training set (e.g., sensor data from sensors 1-10 for products 1-60) and to generate a second trained machine learning model using the second set of features in the training set (e.g., sensor data from sensors 11-20 for products 1-60). In some embodiments, the first trained machine learning model and the second trained machine learning model are combined to generate a third trained machine learning model (e.g., which is a better predictor than the first or the second trained machine learning model on its own in some embodiments). In some embodiments, sets of features are used in comparing models overlap (e.g., first set of features being sensor data from sensors 1-15 and second set of features being sensor data from sensors 5-20). In some embodiments, hundreds of models are generated including models with various permutations of features and combinations of models.

At block 314, the system 300 performs model validation (e.g., via validation engine 184 of FIG. 1) using the validation set 304. The system 300 validates each of the trained models (e.g., associated with determining weights of directed edges, methods 500A-C, associated with determining corrective actions and root causes for manufacturing systems, methods 700A-D, etc.) using a corresponding set of features of the validation set 304. For example, system 300 validates the first trained machine learning model using the first set of features in the validation set (e.g., parameters from sensors 1-10 for products 61-80) and the second trained machine learning model using the second set of features in the validation set (e.g., parameters from sensors 11-20 for products 61-80). In some embodiments, the system 300 validates hundreds of models (e.g., models with various permutations of features, combinations of models, etc.) generated at block 312. At block 314, the system 300 determines an accuracy of each of the one or more trained models (e.g., via model validation) and determines whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. The system 300 discards the trained machine learning models that have an accuracy that is below the threshold accuracy (e.g., based on the validation set).

At block 316, the system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow returns to block 312 where the system 300 performs model training using further refined training sets corresponding to further refined sets of features for determining a trained model that has the highest accuracy.

At block 318, the system 300 performs model testing (e.g., via testing engine 186 of FIG. 1) using the testing set 306 to test the selected model 308. The system 300 tests, using the first set of features in the testing set (e.g., sensor data from sensors 1-10 for products 81-100), the first trained machine learning model to determine the first trained machine learning model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where the system 300 performs model training (e.g., retraining) using different training sets corresponding to different sets of features (e.g., sensor data from different sensors). Responsive to determining that the selected model 308 has an accuracy that meets a threshold accuracy based on the testing set 306, flow continues to block 320. In at least block 312, the model learns patterns in the historical data to make predictions and in block 318, the system 300 applies the model on the remaining data (e.g., testing set 306) to test the predictions (e.g., associated with determining weights of directed edges, methods 500A-C, associated with determining corrective actions and root causes for manufacturing systems, methods 700A-D, etc.).

At block 320, system 300 uses the trained model (e.g., selected model 308) to receive current sensor data 346 (e.g., current sensor data 146 of FIG. 1) and determines (e.g., extracts), from the trained model, predictive data 360 (e.g., predictive data 160 of FIG. 1) for determining weights of directed edges and/or determining recommended corrective actions. In some embodiments, the current sensor data 346 corresponds to the same types of features in the historical sensor data 344. In some embodiments, the current sensor data 346 corresponds to a same type of features as a subset of the types of features in historical sensor data 344 that is used to train the selected model 308 (e.g., associated with determining weights of directed edges, methods 500A-C, associated with determining corrective actions and root causes for manufacturing systems, methods 700A-D, etc.).

In some embodiments, current data is received. In some embodiments, current data includes current causality data 356 (e.g., current causality data 176 of FIG. 1) and/or current sensor data 346 (e.g., associated with determining weights of directed edges, methods 500A-C, etc.). In some embodiments, current data includes current recommendation data 336 (e.g., current recommendation data 136 of FIG. 1) and/or current causality data 356 (e.g., associated with determining corrective actions and root causes for manufacturing systems, methods 700A-D, etc.). In some embodiments, at least a portion of the current data is received from sensors (e.g., sensors 126 and/or metrology equipment 128 of FIG. 1) or via user input. In some embodiments, at least a portion of the current data is received from current product knowledge causal graphs and/or current causal strength index matrices or via user input. In some embodiments, the model is re-trained based on the current data. In some embodiments, a new model is trained based on the current recommendation data 336 and the current causality data 356.

In some embodiments, one or more of the blocks 310-320 occur in various orders and/or with other operations not presented and described herein. In some embodiments, one or more of blocks 310-320 are not to be performed. For example, in some embodiments, one or more of data partitioning of block 310, model validation of block 314, model selection of block 316, and/or model testing of block 318 are not to be performed.

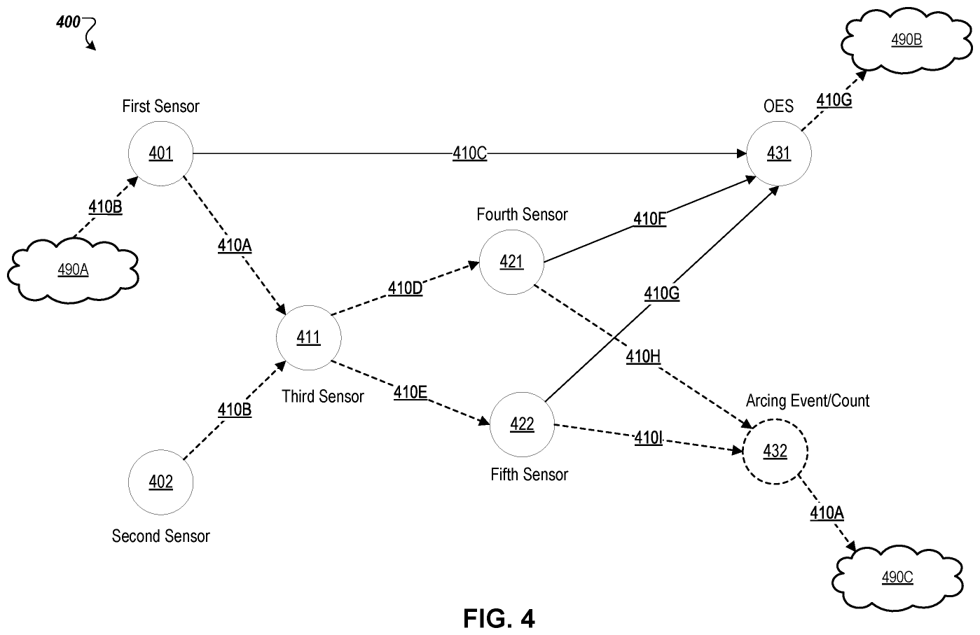

FIG. 4 is a directed acyclic graph (DAG), according to some embodiments.

In some embodiments, causality data may be represented visually using a causal graph such as a DAG. For example, arrows (e.g., edges 410A-I) indicate the direction of causality between nodes (e.g., sensors in a manufacturing system/subsystem). Nodes in a causal graph represent the variables of the manufacturing system (e.g., the sensors, values measured by sensors, sensor data, etc.), and the edges (represented with arrows) between nodes represent the causal relationships between the nodes (e.g., sensors of a manufacturing system/subsystem, sensor data, sensor values, etc.). The direction of the arrow indicates the direction of causality, with the tail of the arrow indicates the cause and the head of the arrow indicating the effect. DAG may be connected to other DAGs showing causal link between nodes of separate systems or subsystems.

In some embodiments, a causal strength index matrix and a causal graph (e.g., DAG) are complementary representations of causality data, where the causal matrix provides a quantitative measure of causality strength (e.g., weights of directed edges of a DAG) and the causal graph provides a visual representation of the causal relationships between variables.

In some embodiments, determining a structural graph proposal can be accomplished by using Informational theory probabilistic methods. Informational theory probabilistic methods are statistical methods used to determine whether there is a cause-and-effect relationship between two variables. Some of the examples of informational theory probabilistic methods may include Granger causality, transfer entropy measures, cross-entropy measures, partial directed coherence, linear and non-linear conditional independence tests, and/or the like.

In some embodiments, determining a structural graph proposal can be accomplished by extending causality tests over all sensors (e.g., nodes) of the system. Causality tests may also be used on the sensor data to generate a causal strength index matrix. In some embodiments, the causal strength index matrix may be based on at least one of, Granger causality, transfer entropy measures, cross-entropy measures, causality tests, or partial directed coherence, or linear and non-linear conditional independence tests. Causal strength index matrix provides a quantitative measure of the strength of the causal relationships between different variables, sensors, or sensor values measured in the system. In some embodiments, degree centrality is a measure used to evaluate the importance of a sensor (e.g., node) in the causal strength index matrix. The number of connections that a node (e.g., sensors) has with other nodes in the matrix determines the degree centrality. Nodes with a high degree centrality may be considered more important and influential in a system. Causal strength index matrix may also be generated by considering degree centrality and transfer entropy measures for a set of data (e.g., sensor data).

In some embodiments, if no data (e.g., sensor data) is available to determine weights, a count of how many nodes (e.g., sensors) another node (e.g., sensor) affects may be used to determine sensor criticality. In some embodiments, the sum of the weights of all the causal edges (edges indicating the nodes effect on other nodes) of the node may be used to determine sensor criticality.

In some embodiments a causal graph proposal (e.g., generated using techniques described above) may be validated and refined by subject matter expert (e.g., a user). For example, a causality test may have indicated a bi-directional edge between two nodes A and B. In some embodiments, a subject matter expert might determine that the edge is not bi-directional, and the causality flows only from A to B. In another example, a causality test may have indicated a directed edge between two nodes A and B. In some embodiments, a subject matter expert might determine that the edge is bi-directional, and the causality flows from A to B and B to A. In some embodiments, a DAG or DAG proposal that is refined by user input (e.g., by subject matter expert) may be referred to as a causal knowledge DAG.

In some embodiments, DAG 400 represents a wafer manufacturing system or subsystem. DAG 400 includes nodes representing sensors within the wafer manufacturing system or subsystem. For example, DAG 400 may represent a processing chamber. In some embodiments, node 401 represents a first sensor, node 402 represents a second sensor, node 411 represents a third sensor, node 421 represents a fourth sensor, node 422 represents a fifth sensor, node 431 may represent an OES tool, and node 432 may represent an arcing sensor. Each node has a causal relationship with other nodes in the manufacturing system as represented by arrows 410A-I. The direction of the arrow indicates the direction of causality, with the tail of the arrow indicating the cause and the head of the arrow indicating the effect.

In some embodiments, DAG 400 may represent a manufacturing subsystem. DAG 400 may show causal connections within the manufacturing subsystem as well as causal connections with other subsystems. For example, subsystems 490A-C all have causal connections to the subsystem represented by DAG 400, subsystem 490A may be causally related to first sensor 401. For example, changes in a node (sensor) in subsystem 490A may cause changes to first sensor 401. Nodes within DAG 400 may cause changes to other subsystems. For example, OES node 431 may be causally related to subsystem 490B and changes to OES nodes 431 may cause changes to a node (sensor) in 490B. In another example, arcing/event counter 432 may be causally related to subsystem 490C and changes to arcing/event counter 432 may cause changes to a node (sensor) in 490B.

Sensors in a manufacturing system may collect data (e.g., sensor data) that is anomalous (e.g., data and/or measurements values that are outside the expected or normal range for a particular parameter). For example, a sensor collecting anomalous data or values, may indicate a problem or issue with the manufacturing process. For example, a temperature sensor may detect a sudden increase in temperature inconsistent with the normal behavior of the manufacturing process. Such an anomalous behavior from an anomalous sensor may indicate, for example, a miscalibrated sensor, a malfunctioning pressure element, a blocked coolant flow, or some other issue that is affecting the temperature control.

In some embodiments, a causal graph (e.g., DAG 400) allows the root cause and/or root causes of an anomalous sensor to be traced. For example, node 432 may begin to collect anomalous data (e.g., node 432 is an anomalous sensor). Causes of anomalous sensor 432 may be traced using the causal relationships between node 432 and other nodes in the system. For example, dotted arrows 410A, 410B, 410D, 410E, 410H, and 410I show the causal path of node 432. It should be noted that more than one root cause may exist for an anomalous sensor. For example, sensor 432 has causal paths that can be traced back to two distinct sensors (sensor 401 and sensor 402). In order to find the cause(s) of an anomalous sensor 432 the causal path(s) may be followed to efficiently trouble shoot the anomalous node and discover the root cause(s) of the anomalous behavior. anomalous behavior observed in a sensor may be traced to the Markov blanket or through the causal paths (e.g., dotted arrows for node 432).

In some embodiments, the weights of the DAG may be relearned based on experimental data or observational data (e.g., metrology data of a manufactured substrate). For example, after a DAG in generated based on sensor values, the weights of the DAG can be updated based on metrology data (e.g., measurements of the manufactured semiconductor products).

FIGS. 5A-C are flow diagrams of methods 500A-C associated with determining causality (e.g., determining causality in a manufacturing system) and determining weights of directed edges, according to some embodiments. In some embodiments, methods 500A-C are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In one implementation, method 500A can be performed by a computer system, such as computer system architecture 100 of FIG. 1. In other or similar implementations, one or more operations of method 500A can be performed by one or more other machines not depicted in the figures. In some embodiments, methods 500A-C are performed, at least in part, by predictive system 110. In some embodiments, method 500A is performed by client device 120 and/or predictive system 110 (e.g., predictive component 114). In some embodiments, method 500B is performed by server machine 180 (e.g., training engine 182, etc.). In some embodiments, method 500C is performed by predictive server 112 (e.g., predictive component 114) and/or client device 120 (e.g., corrective action component 122). In some embodiments, a non-transitory storage medium stores instructions that when executed by a processing device (e.g., of predictive system 110, of server machine 180, of predictive server 112, of client device 120, etc.), cause the processing device to perform one or more of methods 500A-C.

For simplicity of explanation, methods 500A-C are depicted and described as a series of operations. However, operations in accordance with this disclosure can occur in various orders and/or concurrently and with other operations not presented and described herein. Furthermore, in some embodiments, not all illustrated operations are performed to implement methods 500A-C in accordance with the disclosed subject matter. In addition, those skilled in the art will understand and appreciate that methods 500A-C could alternatively be represented as a series of interrelated states via a state diagram or events.

FIG. 5A is a flow diagram of a method associated with determining causality in a manufacturing system, according to some aspects of the present disclosure.

Referring to FIG. 5A, in some embodiments, at block 501 the processing logic implementing the method 500A generates a causal graph based on a plurality of values, each value corresponding to a causal relationship between two or more sensors of a plurality of sensors in one or more manufacturing systems. In some embodiments, a causal strength index matrix may be generated before the causal graph. The causal strength index matrix can be generated based on the plurality of values, each corresponding to a causal relationship between two or more sensors of the plurality of sensors in the one or more manufacturing systems. In such a case the causal graph can be determined based on the causal strength index matrix.

In some embodiments, the causal graph can be a directed acyclic graph (DAG). Causal knowledge DAG is generated by combining cause and effect interdependencies from the causal strength index matrix and user input. The DAG (e.g., causal knowledge DAG) includes multiple nodes corresponding to the multiple sensors of the manufacturing system and multiple directed edges having weights, the weights being determined using a structural causal model. The directed edges may show a causal relationship between two variables in one direction (e.g., X causes Y, but Y does not cause X). In causal relationships, one sensor may be a leading indicator (driver) that causes a change in and/or affects another sensor. In some embodiments, temporal lag may aid in determining cause-effect relationship. The DAG may be further refined by a subject matter expert (user) to develop a causal knowledge DAG. In some examples, refinement includes removing edges, adding edges, changing the direction of edges, etc.

In some embodiments, Bayesian Networks and similar techniques (e.g., belief networks) can be used to determine the weights. In this case, the probability distributions (e.g., joint, marginal and conditional) are learned. For example, the expected value of the conditional distribution between two nodes may be measure of the weights.

In some embodiments, at least one of, Granger causality, transfer entropy measures, cross-entropy measures, causality tests, partial directed coherence, linear and non-linear conditional independence tests, and/or the like may be used to extract cause-effect interdependencies and may be used to generate a causal graph structure and directed edges of the causal graph. Data can be collected, for example, by sensors (e.g., sensors 126 of FIG. 1) in a manufacturing system. Causal discovery algorithm may be used to identify causal relationships in the data (e.g., sensor data). For example, at least one of a causal additive model (CAM) algorithm, Greedy equivalence search (GES) algorithm, fast causal inference (FCI) algorithm, inductive causation (IC) algorithm, NOTEARS algorithm, LiNGAM algorithm, interventional distribution adjustment (IDA) algorithm, structural hamming distance (SHD) algorithm, max-min hill-climbing (MMHC) algorithm, fast GES (FGES) algorithm, PC-MCI algorithm, additive noise model (ANM) algorithm, Bayesian network learning (BNL) algorithm, causal graphical neural network (CGNN) algorithm, TETRAD algorithm, DirectLiNGAM algorithm, joint causal inference (JCI) algorithm, information geometric causal inference (IGCI) algorithm, or the like may be used to identify causal relationships in the data. In some embodiments, a causal direction may be assigned to each causal link.

In some embodiments, experimental design for determining causality (e.g., determining causality, causal effects, and weights for making a causal graph) includes randomized experiments. In some embodiments, experimental designs may include full factorial design, partial factorial design, difference-in-differences (DSDs), definitive screening design, crossover design, blocked design, etc. Randomized experiments are more effective when randomization and/or do-blocking covers all causal factors involved. Observational data may also be used for learning weights via structural causal models including the use of matching, instrument variables, and mediation analysis.

In some embodiments, a structural causal model may be represented by equations derived based on the relationships between variables of a manufacturing system and may be used to determine the weights of edges of a DAG (e.g., a causal knowledge DAG). In some embodiments, the weights (e.g., strength of correlation) of the edges of the DAG and/or causal knowledge DAG may be determined based on at least one of bivariate auto regressive coefficients, partial directed coherence, transfer entropy, partial correlation, or conditional independence. The relationships between the variables of a system may be determined by user input (e.g., a subject matter expert) and/or Granger causality, transfer entropy measures, cross-entropy measures, causality tests, partial directed coherence, linear and non-linear conditional independence tests, and/or the like. The weights of the DAG and/or causal knowledge DAG may be determined using transfer entropy, a cross-correlation function, a cross-conditional independence test, partial directed coherence, granger causality, Geweke causality, or phase slope index. The weights of the DAG and/or causal knowledge DAG may be determined using sensor data, and at least one of transfer entropy, cross-correlation functions, cross-conditional independence tests, spectral methods (e.g., partial directed coherence), and/or the like. Spectral methods include directed transfer functions, isolated effective coherence, and/or the like.

In some embodiments, the relationships may be represented as mathematical equations or probability distributions (e.g., as in Bayesian Networks and belief networks), which relate the variables in the manufacturing system to each other. The equations representing the structural causal model can be used to simulate the behavior of the system under different conditions (e.g., using do-calculus), and to make predictions about the effects of interventions or changes to the system and the weights of the edges (e.g., by isolating one variable in the system and observing effects on system when the variable is changed). Do-calculus rules may provide a set of operations to manipulate a structural causal model and derive the causal relationships between variables. By applying these rules and/or techniques for determining weights, a DAG (having weighted directed edges) may be generated that represents the causal relationships between variables in the structural causal model.

The equations representing a structural causal model may be derived using different techniques. For example, linear regression, decision trees, random forests, gradient boosting machines, neural networks, deep neural networks, Bayesian networks, support vector machines, K-nearest neighbors, principal component analysis, independent component analysis, non-negative matrix factorization, Gaussian mixture models, hidden Markov models, Markov decision processes, reinforcement learning, association rule mining, clustering algorithms, dimensionality reduction techniques, ensemble methods, and/or the like may be used to generate a structural causal model.

In some embodiments, the processing logic may assign a criticality value to each of the multiple sensors and edges of the manufacturing system. Criticality value may be a numerical value representing the critically of a sensor to a system. The processing logic may assign a system health factor index value to the manufacturing system and/or a subsystem of the manufacturing system (e.g., a processing chamber of the manufacturing system). The system health factor index value may be calculated based on a number of anomalous sensors and the corresponding criticality values of the anomalous sensors. Anomalous sensor is a sensor and/or metrology tool that is collecting anomalous data (e.g., measurements that are outside the expected or normal range for a particular parameter). The system health factor index value may be normalized using the weights of the plurality of directed edges corresponding to the anomalous sensors.

In some embodiments, the processing logic may further determine the weights (e.g., of the directed edges) using the structural causal model, where the structural causal model is a trained machine learning model, and where the determining of the weights includes providing sensor data as input to the trained machine learning model and receiving output associated with predictive data, where the weights of the directed edges (e.g., causality data) are associated with the predicted data.

The trained machine learning model is trained with data input including historical sensor data and target output of historical weights data (e.g., causality data).

At block 502, the processing logic determines a causal strength index matrix. In some embodiments, the causal strength index matrix can be determine based on the generated causal graph. The causal strength index matrix can be determined from observational data using a causal discovery algorithm or user input (e.g., user input from a subject matter expert). The causal strength index matrix includes causality data and may include a matrix of coefficients quantifying the strength (e.g., weight) and direction of the causal relationships between pairs of variables (e.g., sensors in the manufacturing system, sensor data collected by sensors in the manufacturing system, etc.). The causal index matrix coefficients may include values (e.g., criticality values, severity values, etc.) calculated using statistical or machine learning methods.

In some embodiments, determining of the causal strength index matrix of the manufacturing system is based on at least one of, Granger causality, transfer entropy measures, cross-entropy measures, causality tests, partial directed coherence, linear and non-linear conditional independence tests, and/or the like.

At block 503, the processing logic responsive to identifying an anomalous behavior in at least one of the multiple sensors, determines a root cause of the anomalous behavior using the causal graph.

Identifying anomalous behavior in at least one of the multiple sensors may include statistical-based fault detection and classification (FDC). In FDC, statistical process control techniques like control charts are used to monitor sensor data. In some embodiments, anomalous sensors may be detected when sensor readings fall outside predefined control limits or exhibit statistically significant trends, shifts, or patterns that deviate from the expected behavior.

In some embodiments, identifying anomalous behavior in at least one of the multiple sensors may include use of guard banding algorithms. In some embodiments, use of guard banding algorithms includes setting predefined tolerance limits around expected sensor values. Sensors may be flagged as anomalous when the readings of the sensor exceed the specified guard bands, indicating a deviation from the acceptable range.

In some embodiments, identifying anomalous behavior in at least one of the multiple sensors may include use of machine learning-based anomaly detection methods, such as autoencoders or isolation forests. In some embodiments, such machine learning methods may be trained on historical sensor data to learn historical data patterns of non-anomalous sensors. In some embodiments, anomalous sensors may be detected when sensor readings significantly deviate from the learned patterns.

In some embodiments, identifying anomalous behavior in at least one of the multiple sensors may include rule-based anomaly detection, pattern recognition techniques, comparative analysis, and/or the like.

In some embodiments, responsive to identifying an anomalous behavior in the at least one of the plurality of sensors, the processing logics determines multiple root causes of the anomalous behavior using at least one of the causal strength index matrix or the causal graph, where each of the multiple root causes is ranked based on a corresponding severity value. In some embodiments, the severity value may be based on the criticality of the root cause, a severity of the root cause, a frequency of occurrence of the root cause, etc.

At block 504, the processing logic causes a recommended corrective action to be issued based on the root cause of the anomalous behavior. The causal graph may provide a graph-based logging method for observed issues and for developing a recommendation system for corrective actions. In some embodiments, a recommender system may improve with more data and rank recommendations based on occurrence. The processing logic may cause multiple recommended corrective actions to be issued based on the multiple root causes of the anomalous behavior, where each of the multiple corrective actions corresponds to at least one of the multiple root causes and is ranked based on a corresponding severity value of a corresponding root cause.

In some embodiments, the processing logic may cause multiple recommended corrective actions to be issued based on the system health factor index value meeting a criterion. The criterion represents a threshold system health and if the system health falls below a determined level the corresponding system health factor index values meets the corresponding criterion.

In some embodiments, the manufacturing system may be a wafer manufacturing system, and the multiple sensors monitor multiple parameters of the wafer manufacturing system.

FIG. 5B is a flow diagram of a method for training a machine learning model (e.g., model 190 of FIG. 1) for determining predictive data (e.g., predictive data 160 of FIG. 1) associated with determining weights of directed edges, according to aspects of the present disclosure.

Referring to FIG. 5B, at block 510 of method 500B, the processing logic identifies historical sensor data (e.g., historical sensor from a sensor of a manufacturing system, historical sensor data 144, etc.). Historical sensor data may include data from historical processing operation runs, historical manufacturing operations, historical substrates, historical processing chamber sensor data, historical manufacturing system sensor data, and/or the like.

In some embodiments, at block 512, the processing logic identifies historical causality data (e.g., weights data, weights of directed edges of DAG, historical weights, historical weights values, historical causality data 174 of FIG. 1, etc.) of one or more historical DAGs of one or more manufacturing systems, subsystems (e.g., processing chambers), and/or the like. Historical causality data may include historical weights values (e.g., weights of directed edges of a DAG, weights values of directed edges of a DAG, etc.) from historical manufacturing system and/or subsystems. For example, historical causality data may include weight values of a causal relationship between two sensors in a manufacturing system (e.g., a weight value of a causal relationship between temperature and pressure, and/or the like). Causality data, including historical causality data, may include sensor data and/or metrology data (e.g., associated with a manufacturing system, processing chamber and/or a substrate before, during, and/or after a process). Causality data, including historical causality data, may include user input (e.g., user input from a subject matter expert) that indicates the weight and/or direction of a causal relationship between two nodes of a DAG (e.g., a causal knowledge DAG) representing a manufacturing system.

Causality data, including historical causality data, may include sensor data and/or metrology data or user input that indicates the direction of causality between to nodes of a DAG representing a manufacturing system. For example, a causal discovery algorithm may indicate erroneously that a there is a causal relationship between reflected power and arcing where arcing causes reflected power. In some embodiments, user input (e.g., from a subject matter expert) indicates that reflected power causes arcing and the directed edge of a DAG may be changed show the appropriate causal relationship. At least a portion of the historical sensor data and the historical causality data may be associated with wafer manufacturing systems. At least a portion of the historical sensor data and the historical causality data may be associated with wafer manufacturing subsystems (e.g., processing chambers).

At block 514, the processing logic trains a machine learning model using data input including historical sensor data 144 (e.g., historical sensor values) and/or target output including the historical causality data 174 (e.g., historical weights data, historical weights values of directed edges of a DAG, etc.) to generate a trained machine learning model.

In some embodiments, the historical sensor data is of historical manufacturing systems/subsystems, and/or the historical causality data corresponding to the historical manufacturing systems/subsystems. The historical sensor data corresponds to sensor values during manufacturing operations, manufacturing processes, manufacturing runs and/or the like. The historical sensor data includes historical sensor values of historical manufacturing operations and/or the historical causality data corresponds to the historical manufacturing systems/subsystems. The historical causality data may be associated with weights of directed edges, direction of directed edges, causal relationships between nodes of a causal graph, etc. The historical causality data may be associated with causal relationships of sensors in a manufacturing system/subsystem, such as the direction and weight of a causal relationship (e.g., as depicted by a weighted directed edge in a DAG).

FIG. 5C is a method 500C for using a trained machine learning model (e.g., model 190 of FIG. 1) associated with determining weights of directed edges, according to some embodiments.

Referring to FIG. 5C, at block 520 of method 500C, the processing logic identifies sensor data. The sensor data of block 520 includes sensor values from sensors of a manufacturing system, and/or the like.

At block 522, the processing logic provides the senor data as data input to a trained machine learning model (e.g., trained via block 514 of FIG. 5B). In some embodiments, the trained machine learning model may be associated with determining causality data (e.g., weights data, weights of directed edges of a DAG, strength of a causal relationship between two variables, etc.).

At block 524, the processing logic receives, from the trained machine learning model, output associated with predictive data, where the weights of the directed edges are associated with the predicted data.

At block 526, the processing logic determines, based on the predictive data, the weights of the directed edges.

In some embodiments, the sensor data 142 is sensor values of sensors of a manufacturing system and the trained machine learning model of block 522 was trained using data input including historical sensor values and target output including historical causality data 174 that includes historical weights data of the historical manufacturing system. The predictive data 160 of block 524 may be associated with predicted causality data (e.g., causality data of the manufacturing system) based on sensor data. Responsive to the predicted causality data meeting a threshold value (e.g., weights are statistically significant, p-value for a t-test is below a pre-defined significance level, etc.), the processing logic may finalize the predicted causality data (e.g., weights data). Responsive to the causality data not meeting the threshold value, the process logic may revise the model or the estimation procedure to improve the accuracy of the weights (e.g., use a different estimation algorithm, incorporate more data or additional variables, use a more appropriate model specification, etc.).

In some embodiments, a time series X is said to Granger-cause Y if it can be shown (e.g., through a series of t-tests and F-tests on lagged values of X and with lagged values of Y also included), that those X values provide statistically significant information (e.g., meeting a p-value threshold) about future values of Y. In some embodiments, responsive to the predicted causality data meeting a threshold value (e.g., a statistically significant threshold value, such as a p-value threshold for a t-test, a p-value threshold for an f-test, and/or the like), the processing logic may finalize the predicted causality data (e.g., weights data). Responsive to the predicted causality data not meeting the threshold value, the process logic may revise the model or the estimation procedure to improve the accuracy of the weights (e.g., use a different estimation algorithm, incorporate more data or additional variables, use a more appropriate model specification, etc.).

FIG. 6 is a product knowledge causal graph, according to some embodiments.

In some embodiments, as in FIG. 4, causality data may be represented visually using a causal graph. In some embodiments, the causal graph may be a product knowledge causal graph that includes parts data (e.g., semantic data) and equipment constants data. Arrows (e.g., edges 610A-I) indicate the direction of causality between nodes (e.g., sensors in a manufacturing system/subsystem). As described in previously in FIG. 4, nodes in a causal graph represent the variables of the manufacturing system (e.g., the sensors, values measured by sensors, sensor data, etc.), and the edges (represented with solid arrows) between nodes represent the causal relationships between the nodes (e.g., sensors of a manufacturing system/subsystem, sensor data, sensor values, etc.).

In some embodiments, product knowledge causal graph 600 is a DAG (as in FIG. 4). Product knowledge causal graph 600 may include additional data (e.g., parts data and equipment constants data) associated with nodes 601-606 of the DAG. Product knowledge causal graph 600 may be based on causal relationships between a plurality of sensors in one or more manufacturing systems.

In some embodiments, product knowledge causal graph 600 represents a wafer manufacturing system (e.g., a collection of subsystems) or a subsystem. In some embodiments, product knowledge causal graph 600 includes nodes representing sensors within the wafer manufacturing system or subsystem. For example, product knowledge causal graph 600 may represent a processing chamber. Nodes 601-606 may represent, for example, a delivered power sensor, a series-connected sensor, a shunt-connected sensor, a chamber pressure sensor, an RF power sensor, a match position sensor, a forward power sensor, a reflected power sensor, an OES tool (e.g., an OES spectrometer), an arcing sensor, and/or the like. Each node has a causal relationship with other nodes in the manufacturing system as represented by arrows 610A-I. Direction of the arrow indicates the direction of causality, with the tail of the arrow indicating the cause and the head of the arrow indicating the effect. For example, arrow 610A represents a causal relationship between nodes 601 and 602, where node 601 is a cause of node 602 (e.g., chamber pressure causes match position). Arrow 610B represents a causal relationship between nodes 602 and 605, where node 602 is a cause of node 605 (e.g., RF power causes match position). In some embodiments, a bidirectional arrow may indicate causality in both directions. In systems exhibiting a closed-loop phenomenon, the occurrence of bidirectional causality is common, where outputs recursively become inputs, forming a continuous feedback loop. However, the response time in the system does not necessarily align instantaneously with the initiating action. The data acquisition's temporal resolution may not match the feedback interval of the system. In such scenarios, causally sequential events may be misrepresented as simultaneous occurrences, potentially obscuring the true dynamics of the system's feedback mechanism.

In some embodiments, product knowledge causal graph 600 may include parts data and equipment constants data. Product knowledge causal graph 600 includes parts (e.g., components) 610-614. Nodes (e.g., nodes 601-606) may be associated with parts of the manufacturing system Parts 610-614 may be a source match, RF cable, source generator, spectrograph, optics cable, etc. Each part may have a part number and/or a serial number. Specifications of a part may be contained in a certificate of acceptance. A certificate of acceptance may show that a particular component, part, or product meets standards, specifications, or quality criteria. A certificate of acceptance may also include sematic data (e.g., text).

In some embodiments, product knowledge causal graph 600 may be based on and include parts data of a plurality of parts of the manufacturing system. Each of the plurality of parts may correspond to at least one sensor of the plurality of sensors. For example, product knowledge causal graph 600 includes parts 610-614. Parts 610-614 are represented by rectangular nodes. Dashed lines connecting the rectangular nodes of parts 610-614 to sensor nodes 601-606 show associations with sensor nodes of product knowledge causal graph 600. For example, parts 610 and 612 are associated with sensor node 601. Part 610 is further associated with sensor node 604. Part 611 is associated with sensor node 603 and 602. Parts 613 and 614 are associated with sensor node 606.

In some embodiments, parts data may be static data. Static data may be unchanging data or values, and may be used as reference or configuration data (e.g., parts data in a manufacturing system that remain constant and do not vary over time).

In some embodiments, parts data may include numerical data (e.g., part specification data, values, etc.) and/or sematic data (e.g., text data included in a certificate of acceptance). A user may leave notes in the certificate of acceptance. Such text data may include semantic data.

In some embodiments, product knowledge causal graph 600 may be based on and include equipment constant data of a plurality of equipment constants of the manufacturing system. In some embodiments, each of the plurality of equipment constants may correspond to at least one sensor of the plurality of sensors. For example, product knowledge causal graph 600 includes equipment constants 620-629.

In some embodiments, sensor nodes (e.g., nodes 601-606) may be associated with equipment constants (e.g., system constants) of the manufacturing system. Product knowledge causal graph 600 includes equipment constants 620-629. Equipment constants 620-629 may be, for example, an RF analyzer timeout, RF analyzer stable time, a check tolerance, check limit, monitor timeout, reference check limit, intensity fault limit, RF on for an eye diagram tool, etc. Each equipment constant is configurable and may be adjusted. The configured value of an equipment constant may be equipment constant data. In some embodiments, equipment constants may be included in product knowledge causal graph 600.

In some embodiments, equipment constant data may be static data. For example, an equipment constant may not be tunable and remains the same. Static data may be unchanging data or values, and may be used as reference or configuration data (e.g., equipment constants in a manufacturing system that remain constant and do not vary over time). Equipment constant data may be dynamic data. Equipment constants that are dynamic (e.g., tunable equipment constants) may be included in product knowledge causal graph 600 and static equipment constants may be excluded.

In some embodiments, equipment constants 620-629 are represented by diamond-shaped nodes and dotted lines show associations with sensor nodes of product knowledge causal graph 600. For example, equipment constants 620 and 621 are associated with sensor node 601. Equipment constant 621 is further associated with sensor node 605. Equipment constant 622 is associated with sensor nodes 603 and 602. Equipment constant 623 is associated with sensor nodes 603 and 602. Equipment constant 624 is associated with sensor nodes 603 and 602. Equipment constant 625 is associated with sensor node 604. Equipment constant 626 is associated with sensor node 606. Equipment constant 627 is associated with sensor node 606. Equipment constant 628 is associated with sensor node 605. Equipment constant 629 is associated with sensor node 605.

In some embodiments, a causal strength index matrix may be determined based on the generated product knowledge causal graph. A causal strength index matrix and a causal graph (e.g., product knowledge causal graph) may be complementary representations of causality data, where the causal matrix provides a quantitative measure of causality strength (e.g., weights of directed edges of a DAG, product knowledge causal graph, etc.) and the causal graph provides a visual representation of the causal relationships between variables.

In some embodiments a product knowledge causal graph proposal (e.g., generated using techniques described above and in FIG. 4) may be validated and refined by subject matter expert (e.g., a user). For example, a causality test may have indicated a bi-directional edge between two nodes A and B. In some embodiments, a subject matter expert might determine that the edge is not bi-directional, and the causality flows only from A to B. In another example, a causality test may have indicated a directed edge between two nodes A and B. In some embodiments, a subject matter expert might determine that the edge is bi-directional, and the causality flows from A to B and B to A.

Sensors in a manufacturing system may collect data (e.g., sensor data) that is anomalous (e.g., data and/or measurements values that are outside the expected or normal range for a particular parameter). For example, a sensor collecting anomalous data or values, may indicate a problem or issue with the manufacturing process. For example, a temperature sensor may detect a sudden increase in temperature inconsistent with the normal behavior of the manufacturing process. Such an anomalous behavior from an anomalous sensor may indicate, for example, a miscalibrated sensor, a malfunctioning pressure element, a blocked coolant flow, or some other issue that is affecting the temperature control.

In some embodiments, a product knowledge causal graph (e.g., product knowledge causal graph 600) allows the root cause and/or root causes of an anomalous sensor to be traced. An anomalous sensor may be detected and may be flagged. The product knowledge causal graph may be updated to reflect the anomalous sensor. The product knowledge graph causal graph may then be used (e.g., by providing the product knowledge causal graph as input to a trained machine learning model) to determine a root cause of the anomalous behavior and to identify a corrective action (e.g., based on at least a subset of the parts data corresponding to the root cause of the anomalous behavior, or a subset of the equipment constant data corresponding to the root cause of the anomalous behavior).

For example, node 605 may begin to collect anomalous data (e.g., node 605 is an anomalous sensor). In some embodiments, the causes of anomalous sensor 605 may be traced using the causal relationships between node 605 and other nodes in the system. For example, edges (e.g., arrows) 610B-G show the causal path of node 605. It should be noted that more than one root cause may exist for an anomalous sensor. For example, sensor 605 has causal paths that can be traced back to two multiple sensors (sensors 601-604). In order to find the cause(s) of an anomalous sensor 605 the causal path(s) may be followed to efficiently trouble shoot the anomalous node and discover the root cause(s) of the anomalous behavior. In some embodiments, anomalous behavior observed in a sensor can only be traced to the Markov blanket or through the causal paths.

FIGS. 7A-D are flow diagrams of methods 700A-D associated with determining corrective actions and root causes for manufacturing systems, according to some embodiments.

In some embodiments, methods 700A-D are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In one implementation, method 700A can be performed by a computer system, such as computer system architecture 100 of FIG. 1. In other or similar implementations, one or more operations of method 700A can be performed by one or more other machines not depicted in the figures. In some embodiments, methods 700A-D are performed, at least in part, by predictive system 110. In some embodiments, method 700A is performed by client device 120 (e.g., corrective action component 122) and/or predictive system 110 (e.g., predictive component 114). In some embodiments, method 700B is performed by server machine 180 (e.g., training engine 182, etc.). In some embodiments, predictive server 112 (e.g., predictive component 114) and/or client device 120 (e.g., corrective action component 122) performs methods 700C-D (. In some embodiments, a non-transitory storage medium stores instructions that when executed by a processing device (e.g., of predictive system 110, of server machine 180, of predictive server 112, of client device 120, etc.), cause the processing device to perform one or more of methods 700A-D.

For simplicity of explanation, methods 700A-D are depicted and described as a series of operations. However, operations in accordance with this disclosure can occur in various orders and/or concurrently and with other operations not presented and described herein. Furthermore, in some embodiments, not all illustrated operations are performed to implement methods 700A-D in accordance with the disclosed subject matter. In addition, those skilled in the art will understand and appreciate that methods 700A-D could alternatively be represented as a series of interrelated states via a state diagram or events.

FIG. 7A is a flow diagram of a method associated with determining corrective actions for semiconductor manufacturing systems, according to aspects of the present disclosure.

Referring to FIG. 7A, at block 701 the processing logic implementing the method 700A generates a product knowledge causal graph. The product knowledge causal graph is based on causal relationships between a plurality of sensors in one or more manufacturing systems. In some embodiments, a causal strength index matrix may be generated before the causal graph. The causal strength index matrix can be generated based on based on the causal relationships between the plurality of sensors in the one or more manufacturing systems. In such a case the product knowledge causal graph can then be determined based on the causal strength index matrix as well as parts data of the plurality of parts of the manufacturing system, equipment constant data of the plurality of equipment constants of the manufacturing system.

In some embodiments, the one or more manufacturing systems may be wafer manufacturing systems, and the plurality of sensors may monitor a plurality of parameters of the wafer manufacturing systems. The product knowledge causal graph may be based on parts data of a plurality of parts of the manufacturing system, each of the plurality of parts corresponding to at least one sensor of the plurality of sensors. In some embodiments, the product knowledge causal graph may be based on equipment constant data of a plurality of equipment constants of the manufacturing system, the equipment constant data corresponding to at least one sensor of the plurality of sensors.

In some embodiments, the processing logic may further determine relationships between the plurality of parts of the manufacturing system and the plurality of sensors of the manufacturing system, and between the plurality of equipment constants of the manufacturing system and the plurality of sensors of the manufacturing system. In some embodiments, the relationships may be determined based on user input (e.g., from a subject matter expert). In some embodiments, the relationships may be determined using neural net, large language learning model, and/or the like.

At block 702, the processing logic determines a causal strength index matrix. In some embodiments, the causal strength index matrix can be determined based on the product knowledge causal graph.

At block 703, the processing logic determines, responsive to identifying an anomalous behavior in at least one of the plurality of sensors, a root cause of the anomalous behavior using at least one of the causal strength index matrix or the product knowledge causal graph. In some embodiments, identifying anomalous behavior in at least one of the multiple sensors may include statistical-based fault detection and classification (FDC). In FDC, statistical process control techniques like control charts are used to monitor sensor data. For example, anomalous sensors may be detected when sensor readings fall outside predefined control limits or exhibit statistically significant trends, shifts, or patterns that deviate from the expected behavior.

In some embodiments, identifying anomalous behavior in at least one of the multiple sensors may include use of guard banding algorithms. In some embodiments, use of guard banding algorithms includes setting predefined tolerance limits around expected sensor values. Sensors may be flagged as anomalous when the readings of the sensor exceed the specified guard bands, indicating a deviation from the acceptable range. A part corresponding to the sensor may have, for example, a certificate of acceptance, quality data, specification data, etc. of the part may be out of control limits corresponding to the part causing the corresponding sensor to be flagged.

In some embodiments, identifying anomalous behavior in at least one of the multiple sensors may include use of machine learning-based anomaly detection methods, such as autoencoders or isolation forests. Machine learning methods may be trained on historical sensor data to learn historical data patterns of non-anomalous sensors. In some embodiments, anomalous sensors may be detected when sensor readings significantly deviate from the learned patterns.

In some embodiments, identifying anomalous behavior in at least one of the multiple sensors may include rule-based anomaly detection, pattern recognition techniques, comparative analysis, and/or the like.

In some embodiments, the processing logic may further determine, responsive to identifying an anomalous behavior in the at least one of the plurality of sensors, a plurality of root causes of the anomalous behavior using at least one of the causal strength index matrix or the product knowledge causal graph. Each of the plurality of root causes may be ranked based on a corresponding severity value.

In some embodiments, severity data is associated with a causal relationship between two nodes (e.g., the severity of a causal relationship between two or more variables/nodes). The sum of the weights of all the causal edges (edges indicating the nodes effect on other nodes) of the node may be used to determine a sensor criticality. The severity value may be based on the criticality of the root cause, a severity of the root cause, a frequency of occurrence of the root cause, etc. For example, historical data may indicate that a root cause has occurred frequently relative to other root causes causing the severity value of the root cause to increase.

In some embodiments, the processing logic may further identify a plurality of corrective actions based on at least a subset of the parts data corresponding to the plurality of root causes, or a subset of the equipment constant data corresponding to the plurality of root causes. Each of the plurality of corrective actions may correspond to at least one of the plurality of root causes and may be ranked based on the corresponding severity value of the corresponding root cause.

At block 704, the processing logic identifies, based on at least a subset of the parts data corresponding to the root cause of the anomalous behavior, or a subset of the equipment constant data corresponding to the root cause of the anomalous behavior, at least one corrective action for the anomalous behavior.

In some embodiments, the at least one recommended corrective action corresponds to at least one of a part the plurality of parts of the manufacturing system or an equipment constant of the plurality of equipment constants of the manufacturing system. In some embodiments, a recommended corrective actions may indicate an adjustment to an equipment constant, a replacement of a part, and/or the like.

Identifying (e.g., based on at least a subset of the parts data corresponding to the root cause of the anomalous behavior, or a subset of the equipment constant data corresponding to the root cause of the anomalous behavior) at least one corrective action for the anomalous behavior includes providing sensor data as input to a trained machine learning model and receiving output associated with predictive data. The recommended corrective action may be associated with the predicted data. For example, an anomalous sensor may be detected and may be flagged. The product knowledge causal graph may be updated to reflect the anomalous sensor. The product knowledge graph causal graph may then be used (e.g., by providing the product knowledge causal graph as input to a trained machine learning model) to determine a root cause of the anomalous behavior and/or to identify a corrective action.

In some embodiments, the trained machine learning model may be trained with training input data including historical product knowledge causal graphs and historical causal strength index matrices (e.g., causality data), and target output of historical recommendation data. In some embodiments, recommendations data is associated with recommended corrective actions.

In some embodiments, the determining, responsive to identifying an anomalous behavior in at least one of the plurality of sensors, a root cause of the anomalous behavior using at least one of the causal strength index matrix or the product knowledge causal graph includes providing the product knowledge causal graph and the causal strength index matrix (e.g., causality data) as input to a trained machine learning model and receiving output associated with predictive data. In some embodiments, the root cause action may be associated with the predicted data. In some embodiments, the trained machine learning model may be trained with training input data including historical product knowledge causal graphs and historical causal strength index matrices (e.g., causality data), and target output of historical recommendation data (e.g., a root cause, recommended corrective action, etc.). In some embodiments, recommendations data is associated with root causes.

In some embodiments, the root cause may correspond to at least one of a part the plurality of parts of the manufacturing system or an equipment constant of the plurality of equipment constants of the manufacturing system. In some embodiments, a root cause may be associated with a recommended corrective action and may indicate an adjustment to an equipment constant, a replacement of a part, and/or the like.

In some embodiments, the processing logic may identify a plurality of corrective actions based on a system health factor index value meeting a criterion. In some embodiments, the criterion represents a threshold system health and if the system health falls below a determined level the corresponding system health factor index values meets the corresponding criterion.

In some embodiments, the system health factor index value may be calculated based on a number of anomalous sensors detected in the manufacturing system and the corresponding criticality values of the anomalous sensors and may be normalized using the weights of the plurality of directed edges corresponding to the anomalous sensors. In some embodiments, an anomalous sensor is a sensor and/or metrology tool that is collecting anomalous data (e.g., measurements that are outside the expected or normal range for a particular parameter).

In some embodiments, the system health factor index value may indicate the health of the system. In some embodiments a high system health factor index means the system is relatively healthy and a low system factor index means the system is unhealthy. In some embodiments, when the system health factor index value is high and indicates that the system is healthy, a recommended corrective action may not be issued for a detected anomalous sensor or sensors. This is because the causal effect of such anomalous sensors does not have enough weight (e.g., strong causal effect on the outputs of the system), thus a recommended corrective action is not required. In some embodiments, such sensors may have a low criticality.

On the other hand, when the anomalous sensors have higher weights and affect the outputs of the system more significantly, the system health factor index value may be lower (e.g., the system is unhealthy). Under such circumstances a low system health factor index value will cause a recommended corrective action to be identified. In some embodiments, this is because the anomalous sensors have high criticality (e.g., significantly affect the outputs of the system).

In some embodiments, the system health factor index value may indicate the health of a fleet of systems. For example, the system health factor index value of each system in a fleet of system may be statistically combined (e.g., by averaging, weighting, mediating, harmonizing, quantifying, etc.) to give a fleet system health factor index.

FIG. 7B is a flow diagram of a method for training a machine learning model (e.g., model 190 of FIG. 1) for determining predictive data (e.g., predictive data 160 of FIG. 1) associated with determining corrective actions for manufacturing systems, according to aspects of the present disclosure.

Referring to FIG. 7B, at block 710 of method 700B, the processing logic identifies historical causality data (e.g., historical causality data from a product knowledge causal graph and/or a causal strength index matrix of a manufacturing system, historical causality data 174, etc.). Historical causality data may include data from historical product knowledge causal graphs, historical causal strength index matrices, historical manufacturing systems, historical subsystems, and/or the like.

In some embodiments, at block 712, the processing logic identifies historical recommendation data (e.g., historical root causes, root cause data, recommended corrective actions data, historical recommended corrective actions, historical recommendation data 134 of FIG. 1, etc.) of one or more manufacturing systems, subsystems (e.g., processing chambers), and/or the like. Historical recommendation data may include historical root causes and/or recommended corrective actions from historical manufacturing system and/or subsystems. For example, historical recommendation data may include a historical recommended corrective action issued for correction of an anomalous sensor in a manufacturing system (e.g., a recommendation to change a part or component, a recommendation to adjust an equipment constant value, a recommendation to perform maintenance, etc.). Historical recommendation data may include a historical root cause identified as causing an anomalous sensor in a manufacturing system.

In some embodiments, recommendation data, including historical recommendation data, may include user input (e.g., user input from a subject matter expert) that indicates a root cause and/or recommended corrective action for anomalous behavior in a manufacturing system. Recommendation data, including historical recommendation data, may be associated with causality data. For example, a recommended corrective action may be issued based on a root cause of an anomalous behavior, the root cause being determined based on causality data (e.g., using a product knowledge causal graph).

At block 714, the processing logic trains a machine learning model using data input including historical causality data 174 (e.g., historical product knowledge causal graphs, historical causal strength index matrices, etc.) and/or target output including the historical recommendation data 134 (e.g., historical recommended corrective actions data, historical corrective actions, historical root cause data, historical root causes, etc.) to generate a trained machine learning model.

In some embodiments, the historical causality data is of historical manufacturing systems/subsystems (e.g., represented by product knowledge causal graphs and/or causal strength index matrices). In some embodiments, the historical causality data corresponds to product knowledge causal graphs and/or causal strength index matrices, and/or the like. In some embodiments, the historical causality data includes historical product knowledge causal graphs and/or causal strength index matrix values of historical manufacturing systems/subsystems and/or the historical recommendation data corresponds to the historical manufacturing systems/subsystems. The historical recommendation data may be associated with recommended corrective actions, identified root causes, causal relationships between nodes of a causal graph, etc. The historical recommendation data may be associated with causal relationships of sensors in a manufacturing system/subsystem, such as the direction and weight of a causal relationship (e.g., as depicted by a weighted directed edge in a DAG). For example, a first corrective action may be ranked higher than a second corrective action based on the severity values of the corresponding root causes.

FIG. 7C is a method 700C for using a trained machine learning model (e.g., model 190 of FIG. 1) associated with determining corrective actions and identifying root causes for manufacturing systems, according to some embodiments.

Referring to FIG. 7C, at block 720 of method 700C, the processing logic identifies causality data. In some embodiments, the causality data of block 720 includes product knowledge causal graphs, causal strength index matrices, and/or the like.

At block 722, the processing logic provides the causality data as data input to a trained machine learning model (e.g., trained via block 714 of FIG. 7B). In some embodiments, the causality data may be a product knowledge causal graph and/or causal strength index matrix. In some embodiments, the product knowledge causal graph and/or causal strength index matrix may have a node (e.g., sensor) that has been flagged as anonymous. In some embodiments, the trained machine learning model may be associated with determining corrective actions for manufacturing systems (e.g., recommended corrective actions, and/or the like).

At block 724, the processing logic receives, from the trained machine learning model, output associated with predictive data, where the recommended corrective action is associated with the predicted data.

At block 726, the processing logic determines, based on the predictive data, the recommended corrective action.

In some embodiments, the causality data is product knowledge causal graphs and/or causal strength index matrices of a manufacturing system and the trained machine learning model of block 722 was trained using data input including historical product knowledge causal graphs and historical causal strength index matrices, and target output including historical recommendation data that includes historical recommended corrective actions of the historical manufacturing system. The predictive data of block 724 may be associated with predicted recommendation data (e.g., recommendation data for the manufacturing system such as predicted recommended corrective actions) based on causality data. Responsive to the predicted recommendation data meeting a threshold value (e.g., recommendations align with predefined threshold criteria or metrics, etc.), the processing logic may finalize the predicted recommendation data (e.g., recommended corrective actions). Responsive to the recommendation data not meeting the threshold value, the process logic may revise the model or the estimation procedure to improve the accuracy of the recommendations (e.g., use a different recommendation algorithm, incorporate more data or additional variables, use a more appropriate model specification, etc.).

In some embodiments, responsive to the predicted recommendation data meeting a threshold value (e.g., recommendations align with predefined threshold criteria or metrics), the processing logic may finalize the predicted recommendation data (e.g., recommended corrective actions). Responsive to the predicted recommendation data not meeting the threshold value, the process logic may revise the model or the estimation procedure to improve the recommended corrective actions (e.g., use a different recommendation algorithm, incorporate more data or additional variables, use a more appropriate model specification, etc.).

FIG. 7D is a method 700D for using a trained machine learning model (e.g., model 190 of FIG. 1) associated with determining root causes for manufacturing systems, according to some embodiments.

Referring to FIG. 7D, at block 730 of method 700D, the processing logic identifies causality data. In some embodiments, the causality data of block 730 includes product knowledge causal graphs and/or causal strength index matrices, of a manufacturing system, and/or the like.

At block 732, the processing logic provides the causality data as data input to a trained machine learning model (e.g., trained via block 714 of FIG. 7B). In some embodiments, the causality data may be a product knowledge causal graph and/or causal strength index matrix. In some embodiments, the product knowledge causal graph and/or causal strength index matrix may have a node (e.g., sensor) that has been flagged as anonymous. In some embodiments, the trained machine learning model may be associated with determining root causes for manufacturing systems (e.g., root causes of anomalous sensors, and/or the like).

At block 734, the processing logic receives, from the trained machine learning model, output associated with predictive data, where the root cause is associated with the predicted data.

At block 736, the processing logic determines, based on the predictive data, the root cause.

In some embodiments, the causality data is product knowledge causal graphs and/or causal strength index matrices of a manufacturing system and the trained machine learning model of block 732 was trained using data input including historical product knowledge causal graphs and historical causal strength index matrices, and target output including historical recommendation data that includes historical root causes of the historical manufacturing system. The predictive data of block 734 may be associated with predicted recommendation data (e.g., recommendation data for the manufacturing system such as predicted root causes) based on causality data. Responsive to the predicted recommendation data meeting a threshold value (e.g., root causes align with predefined threshold criteria or metrics, etc.), the processing logic may finalize the predicted recommendation data (e.g., root causes, etc.). Responsive to the recommendation data not meeting the threshold value, the process logic may revise the model or the estimation procedure to improve the accuracy of the recommendations (e.g., use a different recommendation algorithm, incorporate more data or additional variables, use a more appropriate model specification, etc.).

In some embodiments, responsive to the predicted recommendation data meeting a threshold value (e.g., root causes align with predefined threshold criteria or metrics), the processing logic may finalize the predicted recommendation data (e.g., root causes, etc.). Responsive to the predicted recommendation data not meeting the threshold value, the process logic may revise the model or the estimation procedure to improve the predicted root causes (e.g., use a different recommendation algorithm, incorporate more data or additional variables, use a more appropriate model specification, etc.).

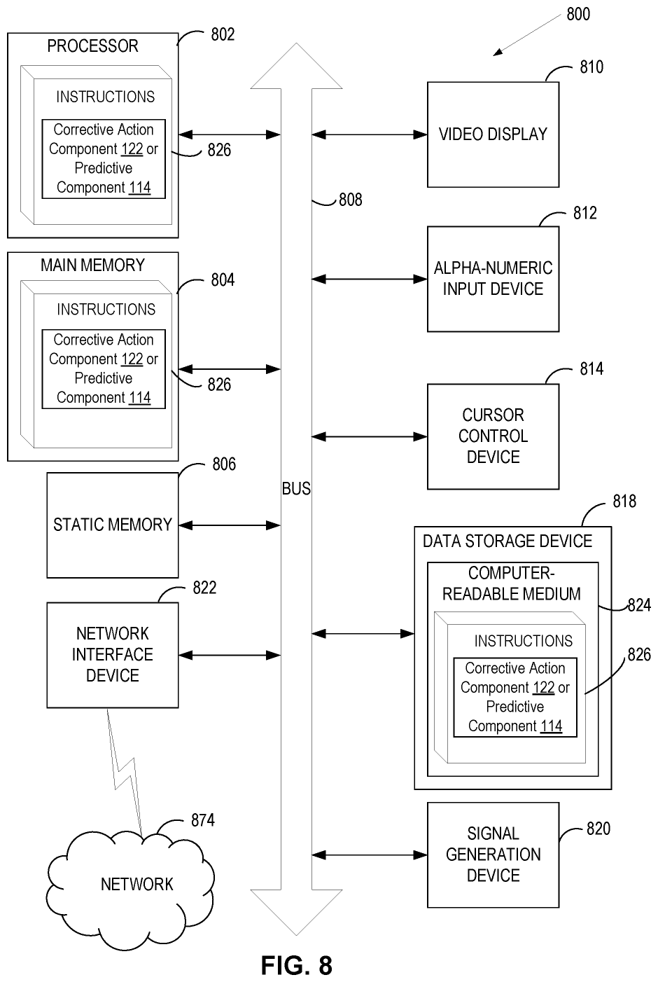

FIG. 8 is a block diagram illustrating a computer system 800, according to certain embodiments. In some embodiments, the computer system 800 is one or more of client device 120, predictive system 110, server machine 170, server machine 180, predictive server 112, and/or the like.

In some embodiments, computer system 800 is connected (e.g., via a network, such as a Local Area Network (LAN), an intranet, an extranet, or the Internet) to other computer systems. In some embodiments, computer system 800 operates in the capacity of a server or a client computer in a client-server environment, or as a peer computer in a peer-to-peer or distributed network environment. In some embodiments, computer system 800 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 includes a processing device 802, a volatile memory 804 (e.g., Random Access Memory (RAM)), a non-volatile memory 806 (e.g., Read-Only Memory (ROM) or Electrically-Erasable Programmable ROM (EEPROM)), and a data storage device 818, which communicate with each other via a bus 808.

In some embodiments, processing device 802 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 800 further includes a network interface device 822 (e.g., coupled to network 874). In some embodiments, computer system 800 also includes a video display unit 810 (e.g., a liquid-crystal display (LCD)), an alphanumeric input device 812 (e.g., a keyboard), a cursor control device 814 (e.g., a mouse), and a signal generation device 820.

In some implementations, data storage device 818 includes a non-transitory computer-readable storage medium 824 on which store instructions 826 encoding any one or more of the methods or functions described herein, including instructions encoding components of FIG. 1 (e.g., corrective action component 122, predictive component 114, etc.) and for implementing methods described herein (e.g., one or more of methods 500A-C and 700A-D).

In some embodiments, instructions 826 also reside, completely or partially, within volatile memory 804 and/or within processing device 802 during execution thereof by computer system 800, hence, in some embodiments, volatile memory 804 and processing device 802 also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as application-specific integrated circuits (ASICS), FPGAS, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “generating,” “identifying,” “determining,” “assigning,” “providing,” “receiving,” “updating,” “causing,” “performing,” “obtaining,” “accessing,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
generating a product knowledge causal graph based on:
causal relationships between a plurality of sensors in one or more manufacturing systems;
parts data of a plurality of parts of the manufacturing system, wherein each of the plurality of parts corresponds to at least one sensor of the plurality of sensors; and
equipment constant data of a plurality of equipment constants of the manufacturing system, wherein the equipment constant data corresponds to at least one sensor of the plurality of sensors;
determining a causal strength index matrix;
responsive to identifying an anomalous behavior in at least one of the plurality of sensors, determining a root cause of the anomalous behavior using at least one of the causal strength index matrix or the product knowledge causal graph; and
identifying, based on at least a subset of the parts data corresponding to the root cause of the anomalous behavior, or a subset of the equipment constant data corresponding to the root cause of the anomalous behavior, at least one corrective action for the anomalous behavior.

2. The method of claim 1, further comprising determining relationships between the plurality of parts of the manufacturing system and the plurality of sensors of the manufacturing system, and between the plurality of equipment constants of the manufacturing system and the plurality of sensors of the manufacturing system, wherein the relationships are determined based on user input.

3. The method of claim 1, wherein the at least one corrective action corresponds to at least one of a part the plurality of parts of the manufacturing system or an equipment constant of the plurality of equipment constants of the manufacturing system.

4. The method of claim 1, further comprising:
responsive to identifying an anomalous behavior in the at least one of the plurality of sensors, determining a plurality of root causes of the anomalous behavior using at least one of the causal strength index matrix or the product knowledge causal graph, wherein each of the plurality of root causes is ranked based on a corresponding severity value; and
identifying a plurality of corrective actions based on at least a subset of the parts data corresponding to the plurality of root causes, or a subset of the equipment constant data corresponding to the plurality of root causes, wherein each of the plurality of corrective actions corresponds to at least one of the plurality of root causes and is ranked based on the corresponding severity value of the corresponding root cause.

5. The method of claim 1, wherein the identifying, based on at least a subset of the parts data corresponding to the root cause of the anomalous behavior, or a subset of the equipment constant data corresponding to the root cause of the anomalous behavior, at least one corrective action for the anomalous behavior comprises:
providing the product knowledge causal graph and the causal strength index matrix as input to a trained machine learning model; and
receiving one or more outputs of the trained machine learning model, the one or more outputs indicating the at least one corrective action.

6. The method of claim 5, wherein the trained machine learning model is trained with training input data comprising historical product knowledge causal graphs and historical causal strength index matrices, and target output of historical recommendation data.

7. The method of claim 1, wherein the determining, responsive to identifying an anomalous behavior in at least one of the plurality of sensors, a root cause of the anomalous behavior using at least one of the causal strength index matrix or the product knowledge causal graph comprises:
providing the product knowledge causal graph and the causal strength index matrix as input to a trained machine learning model; and
receiving one or more outputs of the trained machine learning model, the one or more outputs indicating the root cause.

8. The method of claim 7, wherein the trained machine learning model is trained with training input data comprising historical product knowledge causal graphs and historical causal strength index matrices, and target output of historical recommendation data.

9. A non-transitory computer-readable storage medium storing instructions which, when executed, cause a processing device to perform operations comprising:
generating a product knowledge causal graph is based on:
causal relationships between a plurality of sensors in one or more manufacturing systems;
parts data of a plurality of parts of the manufacturing system, wherein each of the plurality of parts corresponds to at least one sensor of the plurality of sensors; and
equipment constant data of a plurality of equipment constants of the manufacturing system, wherein the equipment constant data corresponds to at least one sensor of the plurality of sensors;
determining a causal strength index matrix;
responsive to identifying an anomalous behavior in at least one of the plurality of sensors, determining a root cause of the anomalous behavior using at least one of the causal strength index matrix or the product knowledge causal graph; and
identifying, based on at least a subset of the parts data corresponding to the root cause of the anomalous behavior, or a subset of the equipment constant data corresponding to the root cause of the anomalous behavior, at least one corrective action for the anomalous behavior.

10. The non-transitory computer-readable storage medium of claim 9, wherein the at least one corrective action corresponds to at least one of a part the plurality of parts of the manufacturing system or an equipment constant of the plurality of equipment constants of the manufacturing system.

11. The non-transitory computer-readable storage medium of claim 9, wherein the operations further comprise:
responsive to identifying an anomalous behavior in the at least one of the plurality of sensors, determining a plurality of root causes of the anomalous behavior using at least one of the causal strength index matrix or the product knowledge causal graph, wherein each of the plurality of root causes is ranked based on a corresponding severity value; and
identifying a plurality of corrective actions based on at least one of parts data corresponding to the plurality of root causes, or equipment constant data corresponding to the plurality of root causes, wherein each of the plurality of corrective actions corresponds to at least one of the plurality of root causes and is ranked based on the corresponding severity value of the corresponding root cause.

12. The non-transitory computer-readable storage medium of claim 9, wherein the identifying, based on at least a subset of the parts data corresponding to the root cause of the anomalous behavior, or a subset of the equipment constant data corresponding to the root cause of the anomalous behavior, at least one corrective action for the anomalous behavior comprises:
providing the product knowledge causal graph and the causal strength index matrix as input to a trained machine learning model; and
receiving one or more outputs of the trained machine learning model, the one or more outputs indicating the at least one corrective action.

13. The non-transitory computer-readable storage medium of claim 12, wherein the trained machine learning model is trained with training input data comprising historical product knowledge causal graphs and historical causal strength index matrices, and target output of historical recommendation data.

14. The non-transitory computer-readable storage medium of claim 9, wherein the determining, responsive to identifying an anomalous behavior in at least one of the plurality of sensors, a root cause of the anomalous behavior using at least one of the causal strength index matrix or the product knowledge causal graph comprises:
providing the product knowledge causal graph and the causal strength index matrix as input to a trained machine learning model; and
receiving one or more outputs of the trained machine learning model, the one or more outputs indicating the root cause.

15. The non-transitory computer-readable storage medium of claim 14, wherein the trained machine learning model is trained with training input data comprising historical product knowledge causal graphs and historical causal strength index matrices, and target output of historical recommendation data.

16. A system comprising:
a memory; and
a processing device coupled to the memory, the processing device to:
generate a product knowledge causal graph based on:
causal relationships between a plurality of sensors in one or more manufacturing systems;
parts data of a plurality of parts of the manufacturing system, wherein each of the plurality of parts corresponds to at least one sensor of the plurality of sensors; and
equipment constant data of a plurality of equipment constants of the manufacturing system, wherein the equipment constant data corresponds to at least one sensor of the plurality of sensors;
determine a causal strength index matrix;
responsive to identifying an anomalous behavior in at least one of the plurality of sensors, determine a root cause of the anomalous behavior using at least one of the causal strength index matrix or the product knowledge causal graph; and
identify, based on at least a subset of the parts data corresponding to the root cause of the anomalous behavior, or a subset of the equipment constant data corresponding to the root cause of the anomalous behavior, at least one corrective action for the anomalous behavior.

17. The system of claim 16, wherein the identifying, based on at least a subset of the parts data corresponding to the root cause of the anomalous behavior, or a subset of the equipment constant data corresponding to the root cause of the anomalous behavior, at least one corrective action for the anomalous behavior comprises:
providing the product knowledge causal graph and the causal strength index matrix as input to a trained machine learning model; and
receiving one or more outputs of the trained machine learning model, the one or more outputs indicating the at least one corrective action.

18. The system of claim 17, wherein the trained machine learning model is trained with training input data comprising historical product knowledge causal graphs and historical causal strength index matrices, and target output of historical recommendation data.

19. The system of claim 16, wherein the determining, responsive to identifying an anomalous behavior in at least one of the plurality of sensors, a root cause of the anomalous behavior using at least one of the causal strength index matrix or the product knowledge causal graph comprises:
providing the product knowledge causal graph and the causal strength index matrix as input to a trained machine learning model; and
receiving one or more outputs of the trained machine learning model, the one or more outputs indicating the root cause.

20. The system of claim 19, wherein the trained machine learning model is trained with training input data comprising historical product knowledge causal graphs and historical causal strength index matrices, and target output of historical recommendation data.
